(19) United States
(12) Patent Application Publication
(10) Pub. No.: US 2026/0044190 A1
(43) Pub. Date: Feb. 12, 2026

(54) FOLDABLE ELECTRONIC DEVICE

(71) Applicant: HiDeep, Inc., Seongnam-si (KR)

(72) Inventors: Ho Jun Moon, Seongnam-si (KR); Seyeob KIM, Seongnam-si (KR); Hyong Cheol SHIN, Seongnam-si (KR)

(21) Appl. No.: 19/290,666

(22) Filed: Aug. 5, 2025

(30) Foreign Application Priority Data
Aug. 7, 2024 (KR) 10-2024-0105594
Jul. 23, 2025 (KR) 10-2025-0100089

(51) Int. Cl. G06F 1/18; G06F 1/16

(52) U.S. Cl. CPC G06F 1/182; G06F 1/1616

(57) ABSTRACT

A foldable electronic device according to an embodiment may include a display panel configured to be folded along a folding axis parallel to a first direction, a plurality of adhesive layers below the display panel, and positioned in an area excluding at least a portion of the folding area that forms a curved surface in a folded state of the display panel, and a magnetic shielding layer attached under the display panel through the plurality of adhesive layers.

### CROSS-REFERENCE TO RELATED APPLICATION

This application is based on and claims priority from Korean Patent Application No. 10-2024-0105594, filed on Aug. 7, 2024 in the Korean Intellectual Property Office, and Korean Patent Application No. 10-2025-0100089, filed on Jul. 23, 2025 in the Korean Intellectual Property Office, the disclosures of which are herein incorporated by reference in their entireties.

### BACKGROUND

### 1. Field

The present disclosure relates to a foldable electronic device.

### 2. Description of Related Art

Touch sensors are installed in various electronic devices such as mobile phones, smart phones, tablet PCs, laptop computers, digital broadcasting terminals, PDAs (Personal Digital Assistants), PMPs (Portable Multimedia Players), and navigation devices.

Within these electronic devices, the touch sensor may be located on a display panel that displays an image, or may be located in an area of the body of the electronic device.

By allowing a user to interact with an electronic device by touching a touch sensor, the electronic device may provide an intuitive user interface to the user.

There is an increasing demand for electronic devices with larger display screens while having the same or smaller volume or thinner thickness than conventional devices, and foldable displays or bendable displays that have a structure that may be folded and unfolded to provide a larger screen only when in use are also being developed.

Meanwhile, a stylus pen may be used for sophisticated touch input on electronic devices with large screens.

Stylus pens may be divided into active stylus pens and passive stylus pens depending on whether they contain batteries and electronic components inside.

Active stylus pens have the advantage of superior basic performance and the ability to provide additional functions (pressure, hovering, buttons) compared to passive stylus pens, but have the disadvantage of being difficult to use while the battery is charging.

Passive stylus pens have the advantage of being cheaper than active stylus pens and not requiring batteries, but have the disadvantage of being less precise in recognizing touch than active stylus pens.

### SUMMARY

One or more example embodiments of the disclosure provide a foldable electronic device with easy use of a stylus pen.

One or more example embodiments of the disclosure provide a foldable electronic device capable of improving touch detection performance by a stylus pen.

According to an aspect of an example embodiment of the disclosure, a foldable electronic device may include a display panel configured to be folded along a folding axis parallel to a first direction, a plurality of adhesive layers below the display panel, and positioned in an area excluding at least a portion of the folding area that forms a curved surface in a folded state of the display panel; and a magnetic shielding layer attached under the display panel through the plurality of adhesive layers.

The plurality of adhesive layers include a first adhesive layer and a second adhesive layer spaced apart in a second direction intersecting the first direction.

A distance between the first adhesive layer and the second adhesive layer in the second direction is substantially the same as the width of the folding area in the second direction.

A distance between the first adhesive layer and the second adhesive layer in the second direction is longer than the width of the folding area in the second direction.

A distance between the first adhesive layer and the second adhesive layer in the second direction is shorter than the width of the folding area in the second direction.

The plurality of adhesive layers include a first adhesive layer and a second adhesive layer spaced apart in a second direction intersecting the first direction, and the foldable electronic device further includes a third adhesive layer positioned between the first adhesive layer and the second adhesive layer along the second direction.

A distance between the first adhesive layer and the second adhesive layer in the second direction is substantially equal to the width of the folding area in the second direction, and a distance in the second direction between the first adhesive layer and the third adhesive layer is substantially the same as a distance in the second direction between the second adhesive layer and the third adhesive layer.

A distance between the first adhesive layer and the second adhesive layer in the second direction is longer than the width of the folding area in the second direction, and a distance in the second direction between the first adhesive layer and the third adhesive layer is substantially the same as a distance in the second direction between the second adhesive layer and the third adhesive layer.

A distance between the first adhesive layer and the second adhesive layer in the second direction is shorter than the width of the folding area in the second direction, and a distance in the second direction between the first adhesive layer and the third adhesive layer is substantially the same as a distance in the second direction between the second adhesive layer and the third adhesive layer.

The plurality of adhesive layers include a first adhesive layer and a second adhesive layer spaced apart in a second direction intersecting the first direction, and the foldable electronic device further includes a third adhesive layer and a fourth adhesive layer positioned between the first adhesive layer and the second adhesive layer along the second direction.

A distance between the first adhesive layer and the second adhesive layer in the second direction is substantially equal to the width of the folding area in the second direction, and a distance in the second direction between the third adhesive layer and the fourth adhesive layer, a distance in the second direction between the first adhesive layer and the third adhesive layer, and a distance in the second direction between the second adhesive layer and the third adhesive layer are substantially the same as each other.

A distance between the first adhesive layer and the second adhesive layer in the second direction is substantially equal to the width of the folding area in the second direction, and a distance in the second direction between the third adhesive layer and the fourth adhesive layer is longer than each of a distance in the second direction between the first adhesive layer and the third adhesive layer and a distance in the second direction between the second adhesive layer and the third adhesive layer.

A distance between the first adhesive layer and the second adhesive layer in the second direction is shorter than the width of the folding area in the second direction, and a distance in the second direction between the third adhesive layer and the fourth adhesive layer is longer than each of a distance in the second direction between the first adhesive layer and the third adhesive layer and a distance in the second direction between the second adhesive layer and the third adhesive layer.

A distance between the first adhesive layer and the second adhesive layer in the second direction is longer than the width of the folding area in the second direction, and a distance in the second direction between the third adhesive layer and the fourth adhesive layer is longer than each of a distance in the second direction between the first adhesive layer and the third adhesive layer and a distance in the second direction between the second adhesive layer and the third adhesive layer.

The third adhesive layer and the fourth adhesive layer are respectively positioned across the boundaries of the second direction of the folding area.

The magnetic field shielding layer includes a plurality of sub-magnetic field shielding layers spaced apart from each other corresponding to the plurality of adhesive layers.

The width of the second direction intersecting the first direction of a first sub-magnetic field shielding layer corresponding to one of the plurality of adhesive layers is different from the width of the second direction of the one adhesive layer.

The width of the second direction intersecting the first direction of a first sub-magnetic field shielding layer corresponding to one of the plurality of adhesive layers is substantially the same as the width of the second direction of the one adhesive layer.

According to an aspect of an example embodiment of the disclosure, a foldable electronic device may include a display panel configured to be folded along a folding axis parallel to a first direction, an adhesive layer positioned below the display panel, and a plurality of magnetic field shielding layers attached under the display panel through the adhesive layer and positioned in an area excluding at least a portion of the folding area that forms a curved surface in a folded state of the display panel.

According to an aspect of an example embodiment of the disclosure, a foldable electronic device may include a display panel configured to be folded along a folding axis parallel to a first direction, a plurality of adhesive layers below the display panel, and positioned in an area excluding at least a portion of the folding area that forms a curved surface in a folded state of the display panel, and a plurality of magnetic field shielding layers attached under the display panel through the plurality of adhesive layers, thicker than the thickness of the plurality of adhesive layers, and positioned in an area excluding at least a portion of the folding area that forms a curved surface in a folded state of the display panel.

According to an aspect of an example embodiment of the disclosure, there is an advantage in that the signal-noise-ratio (SNR) of a signal output from a stylus pen may be improved.

According to an aspect of an example embodiment of the disclosure, there is an advantage in that the reception sensitivity of touch input may be improved.

According to an aspect of an example embodiment of the disclosure, there is an advantage in that more accurate touch positions may be calculated.

According to an aspect of an example embodiment of the disclosure, there is an advantage in that palm rejection may be performed.

According to an aspect of an example embodiment of the disclosure, there is an advantage in that a thinner and smaller form factor may be provided.

### BRIEF DESCRIPTION OF THE DRAWINGS

FIG. 1 is a conceptual diagram showing a stylus pen and a foldable electronic device.

FIG. 2 is a diagram schematically showing a signal transmission operation between a stylus pen and a foldable electronic device.

FIG. 3 is a block diagram schematically showing a foldable electronic device.

FIGS. 4 and 5 are drawings showing stylus pens according to embodiments.

FIGS. 6 and 7 are schematic drawings showing a portion of a touch module according to an embodiment.

FIGS. 8 and 9 are drawings showing foldable electronic devices according to comparative examples.

FIGS. 10 to 47 are drawings showing foldable electronic devices according to embodiments.

FIG. 48 is a block diagram showing a touch module and a host according to embodiments.

FIG. 49 is a diagram showing an example of touch data provided to a host from a touch module according to embodiments.

### DETAILED DESCRIPTION OF THE EMBODIMENTS

Below, various embodiments of this disclosure are described with reference to the attached drawings.

However, it should be understood that this is not intended to limit the technology described in this disclosure to a particular embodiment, but rather to encompass various modifications, equivalents, and/or alternatives of the embodiments of this disclosure.

In connection with the description of the drawings, similar reference numerals may be used for similar components.

In addition, the size and thickness of each component shown in the drawing are arbitrarily shown for convenience of explanation, so the present disclosure is not necessarily limited to what is shown.

To clearly represent the various layers and areas in the drawing, the thickness is enlarged and shown.

And in the drawing, for convenience of explanation, the thickness of some layers and areas is exaggerated.

Also, when we say that a part, such as a layer, membrane, region, or plate, is “over” or “on” another part, this includes not only cases where it is “directly over” the other part, but also cases where there are other parts in between.

Conversely, when we say that a part is “directly above” another part, we mean that there is no other part in between.

Also, being “above” or “on” a reference part means being located above or below the reference part, and does not necessarily mean being located “above” or “on” the opposite direction of gravity.

In this disclosure, the expressions “have”, “can have”, “include”, or “may include” indicate the presence of a feature (e.g., a numerical value, function, operation, or component such as a part), but do not exclude the presence of additional features.

In this disclosure, the expressions “A or B”, “at least one of A or/and B”, or “one or more of A or/and B” may include all possible combinations of the items listed together.

For example, “A or B,” “at least one of A and B,” or “at least one of A or B” may all refer to (1) including at least one A, (2) including at least one B, or (3) including both at least one A and at least one B.

The expressions “first”, “second”, “first”, or “second” used in this disclosure may describe various components, regardless of order and/or importance, and are only used to distinguish one component from other components and do not limit the components.

For example, a first user device and a second user device may represent different user devices, regardless of order or importance.

For example, without departing from the scope of the rights set forth in this disclosure, the first component could be renamed the second component, and similarly, the second component could also be renamed the first component.

When it is said that a component (e.g., a first component) is “(operatively or communicatively) coupled with/to” or “connected to” another component (e.g., a second component), it should be understood that the component may be directly coupled to the other component, or may be coupled through another component (e.g., a third component).

On the other hand, when it is said that a component (e.g., a first component) is “directly connected” or “directly connected” to another component (e.g., a second component), it may be understood that no other component (e.g., a third component) exists between the component and the other component.

The expression “configured to” as used in this disclosure may be used interchangeably with, for example, “suitable for”, “having the capacity to”, “designed to”, “adapted to”, “made to”, or “capable of”.

The term “configured to” may not necessarily mean “specifically designed to” in hardware.

Instead, in some contexts, the expression “a device configured to” may mean that the device is “capable of” doing something in conjunction with other devices or components.

For example, the phrase “a processor configured (or set) to perform A, B, and C” may mean a dedicated processor (e.g., an embedded processor) to perform those operations, or a generic-purpose processor (e.g., a CPU or an application processor) that may perform those operations by executing one or more software programs stored in a memory device.

The terms used in this disclosure are used only to describe particular embodiments and may not be intended to limit the scope of other embodiments.

A singular expression may include a plural expression unless the context clearly indicates otherwise.

Terms used herein, including technical or scientific terms, have the same meaning as commonly understood by one of ordinary skill in the art described in this disclosure.

Terms used in this disclosure that are defined in general dictionaries may be interpreted as having the same or similar meaning in the context of the relevant technology, and shall not be interpreted in an ideal or overly formal meaning unless explicitly defined in this disclosure.

In some cases, even if a term is defined in this disclosure, it cannot be interpreted to exclude embodiments of this disclosure.

An electronic device according to various embodiments of the present disclosure may include, for example, at least one of a smartphone, a tablet personal computer, a mobile phone, a video phone, an e-book reader, a laptop personal computer, a netbook computer, a mobile medical device, a camera, or a wearable device.

According to various embodiments, a wearable device may include at least one of an accessory type (e.g., a watch, a ring, a bracelet, an anklet, a necklace, glasses, contact lenses, or a head-mounted device (HMD)), a fabric or clothing-integrated type (e.g., an electronic garment), a body-attached type (e.g., a skin pad or tattoo), or a bio-implantable type (e.g., an implantable circuit).

Hereinafter, a foldable electronic device and a method of operating the same according to embodiments will be described with reference to necessary drawings.

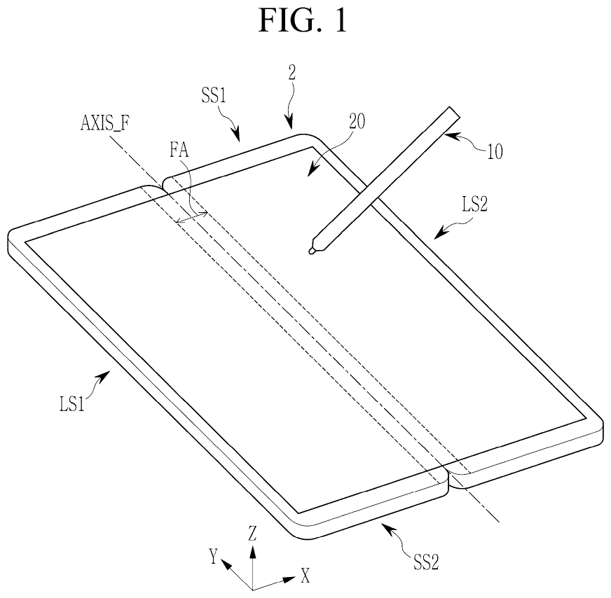

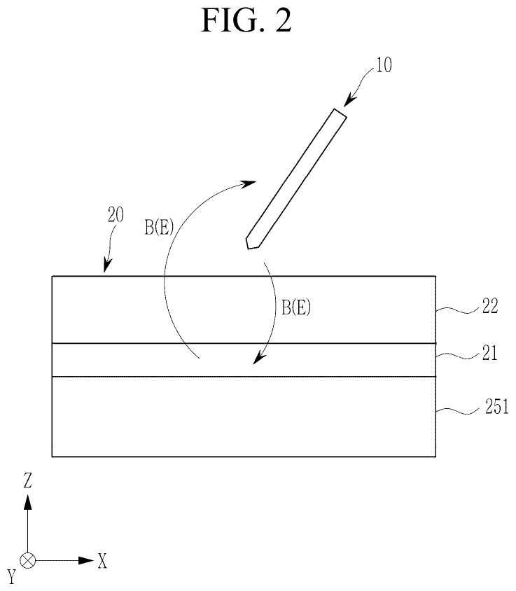

FIG. 1 is a conceptual diagram showing a stylus pen and a foldable electronic device, and FIG. 2 is a diagram schematically showing a signal transmission operation between a stylus pen and a foldable electronic device.

As illustrated in FIG. 1, the stylus pen 10 may receive a signal output from the electronic device 2 or the touch screen 20 near the touch screen 20 of the foldable electronic device 2 and transmit a signal to the touch screen 20.

In a foldable electronic device 2 having a rectangular shape or a member such as a touch screen 20 included in the foldable electronic device 2, the long side located on the left side of the plane is referred to as the first long side LS1, the long side located on the right side is referred to as the second long side LS2, the short side located above is referred to as the first short side SS1, and the short side located below is referred to as the second short side SS2.

The foldable electronic device 2 may be bent along a predetermined folding direction based on a folding axis AXIS_F crossing the first short side SS1 and the second short side SS2.

That is, the foldable electronic device 2 may be switched between a folded state and an unfolded state along the folding direction based on the folding axis AXIS_F.

As shown in FIG. 2, the touch screen 20 includes a display panel 251, a touch electrode layer 21, and a window 22.

In the case of a stylus pen 10 including a resonant circuit, when the electrode of the touch electrode layer 21 transmits a magnetic signal B and/or an electric signal E to the stylus pen 10, the resonant circuit included in the stylus pen 10 resonates to the magnetic signal B and/or the electric signal E.

Then, the electrode of the touch electrode layer 21 may receive a resonant electric signal E and/or magnetic signal B from the stylus pen 10.

Since the touch screen 20 does not require an additional unit or module to transmit a magnetic signal to the stylus pen 10, the touch screen 20 may be made thinner and has an advantage in manufacturing cost.

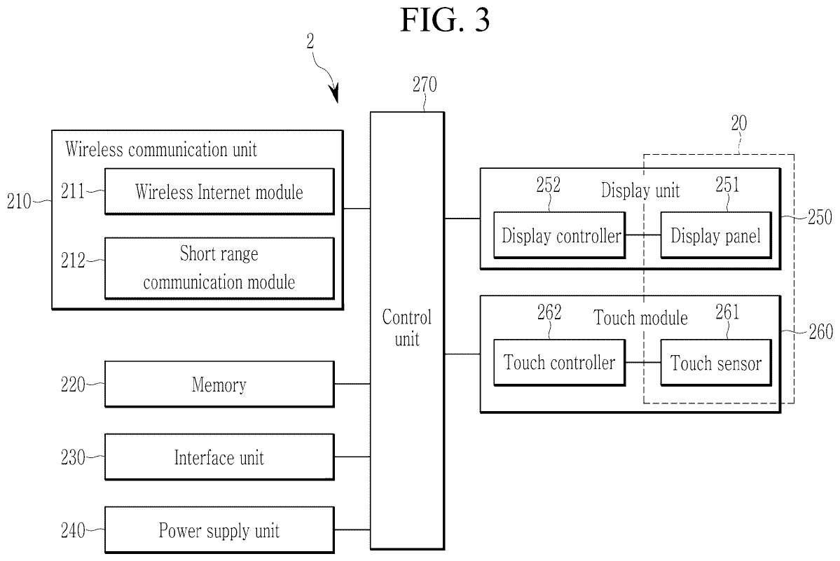

FIG. 3 is a block diagram schematically showing a foldable electronic device.

Referring to FIG. 3, the foldable electronic device 2 may include a wireless communication unit 210, a memory 220, an interface unit 230, a power supply unit 240, a display unit 250, a touch module 260, and a control unit 270.

The components illustrated in FIG. 3 are not essential for implementing an electronic device, and thus, the electronic device described in the present disclosure may have more or fewer components than the components listed above.

More specifically, among the above components, the wireless communication unit 210 may include one or more modules that enable wireless communication between the foldable electronic device 2 and a wireless communication system, between the foldable electronic device 2 and another foldable electronic device 2, or between the foldable electronic device 2 and an external server.

Additionally, the wireless communication unit 210 may include one or more modules that connect the foldable electronic device 2 to one or more networks.

This wireless communication unit 210 may include a wireless Internet module 211 and a short-range communication module 212.

The wireless Internet module 211 refers to a module for wireless Internet access and may be embedded into a foldable electronic device 2.

The wireless Internet module 211 is configured to transmit and receive wireless signals in a communication network according to wireless Internet technologies.

Wireless Internet technologies include, for example, WLAN (Wireless LAN), Wi-Fi (Wireless-Fidelity), Wi-Fi (Wireless Fidelity) Direct, DLNA (Digital Living Network Alliance), WiBro (Wireless Broadband), WiMAX (World Interoperability for Microwave Access), HSDPA (High Speed Downlink Packet Access), HSUPA (High Speed Uplink Packet Access), LTE (Long Term Evolution), LTE-A (Long Term Evolution-Advanced), etc., and the wireless Internet module 211 transmits and receives data according to at least one wireless Internet technology, including Internet technologies not listed above.

The short-range communication module 212 is for short-range communication and may support short-range communication by using at least one of Bluetooth, RFID (Radio Frequency Identification), Infrared Data Association (IrDA), UWB (Ultra Wideband), ZigBee, NFC (Near Field Communication), Wi-Fi (Wireless-Fidelity), Wi-Fi Direct, and Wireless USB (Wireless Universal Serial Bus) technologies.

Such a short-range communication module 212 may support wireless communication between a foldable electronic device 2 and a wireless communication system, between a foldable electronic device 2 and a wireless communication capable device, or between a touch sensor 2 and a network where an external server is located via a short-range wireless communication network WLAN.

The above short-range wireless communication network may be a short-range wireless personal area network (Wireless Personal Area Networks).

Here, the wireless communication capable device may be a mobile terminal (e.g., a smart phone, a tablet PC, a notebook, etc.) capable of exchanging data with (or linking with) the foldable electronic device 2 according to the present invention.

The short-range communication module 212 may detect (or recognize) a wireless communication capable device capable of communicating with the foldable electronic device 2 around the foldable electronic device 2.

Furthermore, if the detected wireless communication capable device is a device authenticated to communicate with the foldable electronic device 2 according to an embodiment, the control unit 170 may transmit at least a portion of the data processed in the foldable electronic device 2 to the wireless communication capable device via the short-range communication module 212.

Accordingly, a user of a wireless communication capable device may use data processed in a foldable electronic device 2 through the wireless communication capable device.

Additionally, the memory 220 stores data that supports various functions of the foldable electronic device 2.

The memory 220 may store a plurality of application programs (or applications) driven by the foldable electronic device 2, data for the operation of the foldable electronic device 2, and commands.

The interface unit 230 serves as a passageway for various types of external devices connected to the foldable electronic device 2.

This interface unit 230 may include at least one of a wired/wireless headset port, an external charger port, a wired/wireless data port, a memory card port, a port for connecting a device equipped with an identification module, an audio I/O (Input/Output) port, a video I/O (Input/Output) port, and an earphone port.

The power supply unit 240 receives external power and internal power under the control of the control unit 270 and supplies power to each component included in the foldable electronic device 2.

This power supply unit 240 includes a battery, which may be a built-in battery or a replaceable battery.

The display unit 250 displays (outputs) information processed in the foldable electronic device 2.

For example, the display unit 250 may display execution screen information of an application running on a foldable electronic device 2, or UI User Interface or GUI (Graphic User Interface) information according to such execution screen information.

The display unit 250 may include a liquid crystal display (LCD display), an organic light-emitting diode (OLED) display, an e-ink display, a quantum-dot light-emitting display, a micro LED (Light emitting diode) display, etc.

The display unit 250 includes a display panel 251 that displays an image, and a display controller 252 that is connected to the display panel 251 and supplies signals for displaying an image to the display panel 251.

For example, a display panel 251 may have a plurality of pixels connected to signal lines such as a plurality of scan lines and a plurality of data lines, and a scan driver that supplies scan signals to the scan lines, and a display controller 252 may include a data driver IC that generates a data signal applied to the data lines, a timing controller that processes an image signal and controls the overall operation of the display unit 250, a power management IC, etc.

The touch module 260 detects a touch (or touch input) to the touch area using a capacitive method.

As an example, the touch module 260 may be configured to convert changes in electrostatic capacitance, voltage, or current generated at a specific location into an electrical input signal.

The touch module 260 may be configured to detect the location, area, electrostatic capacity at the time of touch, etc. of a touch object that touches a touch area on the touch module 260.

Here, the touch object is an object that applies a touch to the touch sensor, and may be, for example, a user's body part (finger, palm, etc.), a passive or active stylus pen 10, etc.

The touch module 260 includes a touch sensor 261 where a touch electrode is positioned, and a touch controller 262 that applies a driving signal to the touch sensor 261, receives a detection signal from the touch sensor 261, and transmits touch data to the control unit 270 and/or the display controller 252.

The display panel 251 and the touch sensor 261 may be formed in a mutual layer structure or as an integral part, and may be referred to as a touch screen 20.

The control unit 270 controls the operation of the foldable electronic device 2 and may output touch coordinate information in response to the touch detection result of the foldable electronic device 2.

Additionally, the control unit 270 may change the frequency of the driving signal in response to the touch detection result.

In addition to the operations related to the above application, the control unit 270 typically controls the overall operation of the foldable electronic device 2.

The control unit 270 may process signals, data, information, etc. input or output through the components examined above, or operate an application program stored in the memory 270 to provide or process appropriate information or functions to the user.

Additionally, the control unit 270 may control at least some of the components examined with reference to FIG. 3 to drive an application program stored in the memory 270.

Furthermore, the control unit 270 may operate at least two or more of the components included in the foldable electronic device 2 in combination to drive the application program.

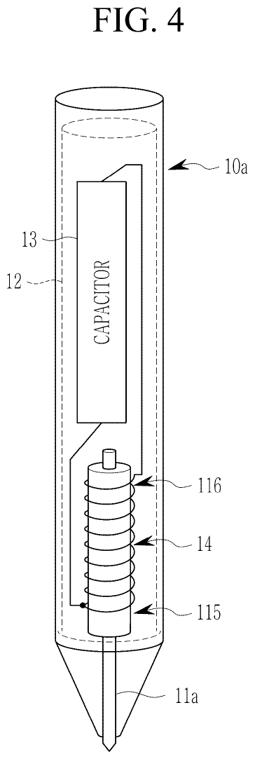

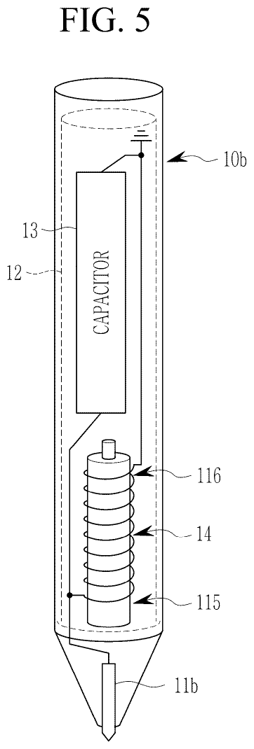

FIGS. 4 and 5 are drawings showing stylus pens according to embodiments.

The stylus pens 10a, 10b of FIGS. 4 and 5 may commonly include a resonant circuit 12 within the housing.

The resonant circuit 12 is an LC resonant circuit and may resonate with the driving signal output from the touch screen 20.

The driving signal may include a signal (e.g., sine wave, square wave, etc.) having a frequency corresponding to the resonant frequency of the resonant circuit 12.

For resonance, the resonant frequency of the resonant circuit 12 and the frequency of the driving signal may need to be the same or very similar.

The resonant frequency of the stylus pen 10a, 10b may depend on the design value of the resonant circuit 12 of the stylus pen 10a, 10b.

The elements of the stylus pen 10a, 10b may be accommodated in the housing.

The housing may have, but is not limited to, the shape of a cylinder, a polygonal cylinder, a column having at least a portion of a curved surface, an entasis shape, a frustum of a pyramid shape, a circular truncated cone shape, etc.

Since the housing is hollow on the inside, it may accommodate elements of a stylus pen 10a, 10b, such as a resonant circuit 12, inside it.

Such housing may be made of a non-conductive material.

Referring to FIG. 4, an EMR type stylus pen 10a may include a body 11a and a resonance circuit 12.

The resonant circuit section 12 may include an inductor section 14 and a capacitor section 13.

The inductor section 14 may include a ferrite core 115 through which the body 11a penetrates and a coil 116 wound on the outer surface of the ferrite core 115.

The core 11a may have one end protruding from the ferrite core 115 as a pen tip.

The core 11a may be composed of an electrode core made of a hard resin mixed with a conductor, for example, a conductive metal or conductive powder.

In the ferrite core 115, for example, a cylindrical ferrite material may have a through hole formed in the axial direction with a predetermined diameter (e.g., 1 mm) for inserting and passing a core body 11a.

The coil 116 may be wound over the entire axial length of the ferrite core 115, or may be wound over a portion of the length.

The coil 116 may be electrically connected to the capacitor section 13.

The capacitor section 13 may include a plurality of capacitors connected in parallel.

Each capacitor on a printed circuit board may have different capacitances and may be trimmed during the manufacturing process.

Referring to FIG. 5, an Electrically Coupled Resonance ECR type stylus pen 10b may include a conductive tip 11b and a resonant circuit 12.

The resonant circuit section 12 may include an inductor section 14 and a capacitor section 13.

The inductor section 14 may include a ferrite core 115 and a coil 116 wound on the outer surface of the ferrite core 115.

The conductive tip 11b may be formed at least in part of a conductive material (e.g., metal, conductive rubber, conductive fabric, conductive silicone, etc.), but is not limited thereto.

The coil 116 may be wound over the entire axial length of the ferrite core 115, or may be wound over a portion of the length.

The coil 116 may be electrically connected to the capacitor section 13.

The capacitor section 13 may include a plurality of capacitors connected in parallel.

Each capacitor on a printed circuit board may have different capacitances and may be trimmed during the manufacturing process.

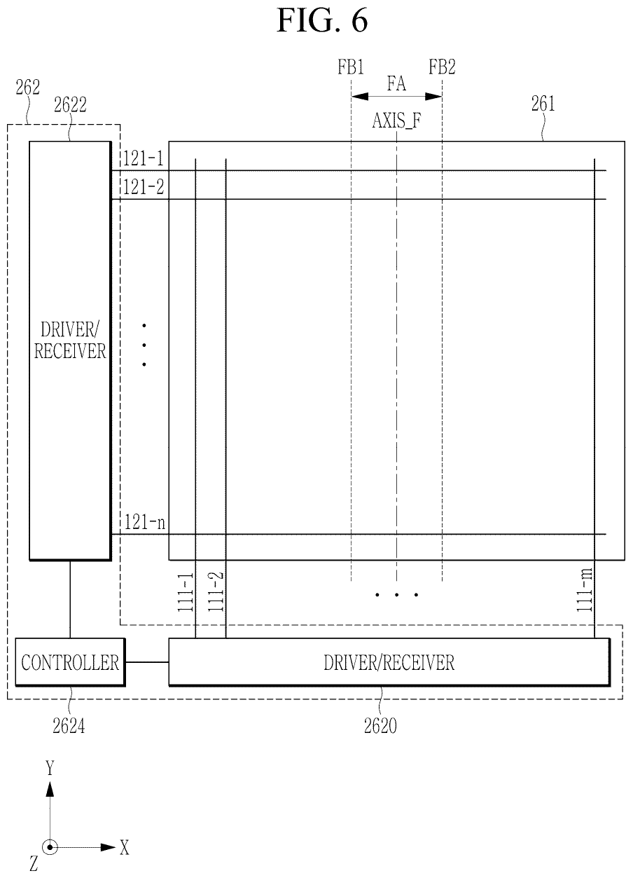

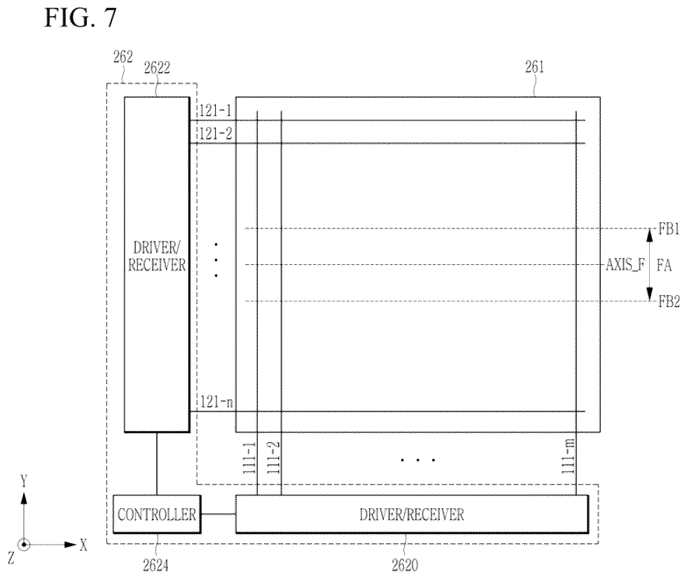

FIGS. 6 and 7 are schematic drawings showing a portion of a touch module according to an embodiment.

Referring to FIGS. 6 and 7, a touch module (i.e., a touch device) 260 may include a touch controller 262 that controls a touch panel 261 and a touch sensor 261.

The touch controller 262 may include a first driving/receiving unit 2620 and a second driving/receiving unit 2622 that transmit and receive signals with the touch panel 261, and a control unit 2624.

The touch panel 261 may include a plurality of first touch electrodes 111-1 to 111-m for detecting touch coordinates in a first direction (e.g., X-axis direction) and a plurality of second touch electrodes 121-1 to 121-n for detecting touch coordinates in a second direction (e.g., Y-axis direction) intersecting the first direction.

For example, a plurality of first touch electrodes 111-1 to 111-m may have a shape extending in the second direction, and a plurality of second touch electrodes 121-1 to 121-n may have a shape extending in the first direction.

Within the touch panel 261, a plurality of first touch electrodes 111-1 to 111-m may be arranged along a first direction, and a plurality of second touch electrodes 121-1 to 121-n may be arranged along a second direction.

In some embodiments, the first driver/receiver unit 2620 may apply a driving signal to a plurality of first touch electrodes 111-1 to 111-m.

The second driving/receiving unit 2622 may receive detection signals from a plurality of second touch electrodes 121-1 to 121-n.

In some embodiments, the first driver/receiver unit 2620 may apply a drive signal to some of the first touch electrodes among the plurality of first touch electrodes 111-1 to 111-m.

The first driver/receiver unit 2620 may receive a detection signal from other first touch electrodes among the plurality of first touch electrodes 111-1 to 111-m.

The second driving/receiving unit 2622 may receive detection signals from a plurality of second touch electrodes 121-1 to 121-n.

Although the touch panel 261 is described above as being implemented in a mutual capacitance manner, the touch panel 261 may be implemented in a self-capacitance manner, and it will be easy for a person skilled in the art to modify the touch electrodes (111-1 to 111-m, 121-1 to 121-n), the first driving/receiving unit 2620, and the second driving/receiving unit 2622 in the mutual capacitance manner to be suitable for the self-capacitance manner by appropriately modifying them, adding new components, or omitting some components.

In an embodiment, the touch panel 261 may include a plurality of self-capacitance type touch electrodes, in which case the touch electrodes may be arranged in a dot shape or may be arranged in a shape extending in one direction as described above.

Referring to FIG. 6, the touch panel 261 of an embodiment may be folded based on a folding axis AXIS_F parallel to the second direction.

When folding of the touch panel 261 occurs based on the folding axis AXIS_F, the folding area (hereinafter, folding area FA) is located between boundaries FB1, FB2 extending in the first direction from the folding axis AXIS_F.

Referring to FIG. 7, the touch panel 261 of an embodiment may be folded based on a folding axis AXIS_F parallel to the first direction.

When folding of the touch panel 261 occurs based on the folding axis AXIS_F, the folding area (hereinafter, folding area FA) is located between boundaries FB1, FB2 extending in the second direction from the folding axis AXIS_F.

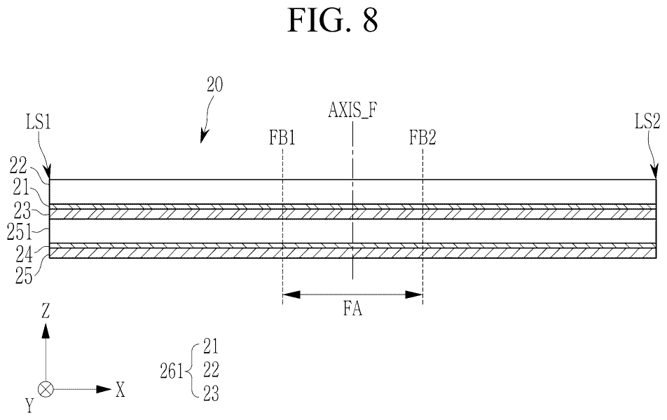

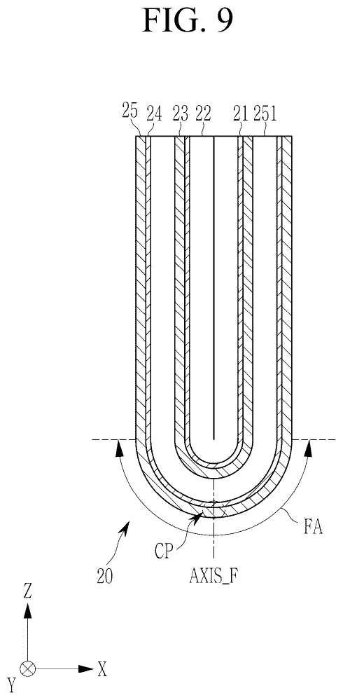

FIGS. 8 and 9 are drawings showing foldable electronic devices according to comparative examples.

The foldable electronic device described herein may have a flat state or unfolded state as illustrated in FIG. 8, a folded state as illustrated in FIG. 9, and an intermediate state between the unfolded state and the folded state.

Here, unless otherwise specifically stated, the term “folded state” means the “fully folded state.”

Referring to FIG. 8, the touch screen 20 of the foldable electronic device includes a display panel 251 and a touch sensor 261 on the display panel 251.

The touch sensor 261 may include a substrate 23, a touch electrode layer 21 on the substrate, and a window 22 on the touch electrode layer 21.

The substrate 23 may be a sealing substrate of the display panel 251 or a color filter substrate of the display panel 251, and is preferably implemented with a transparent material.

The touch electrode layer 21 may include a plurality of first touch electrodes for detecting touch coordinates in a first direction and a plurality of second touch electrodes for detecting touch coordinates in a second direction intersecting the first direction.

In FIG. 8, the touch electrode layer 21 is illustrated as a single layer, but the first touch electrode and the second touch electrode may be positioned in different layers, may be positioned overlapping each other, may not be positioned overlapping each other, and a separate layer may be interposed between the first touch electrode and the second touch electrode, but is not limited thereto.

A window 22 may be positioned on the touch electrode layer 21.

The touch electrode layer 21, the conductive tip 11, and the window 22 may form capacitance.

Accordingly, a signal (resonance signal or active touch signal) generated from the stylus pen 10 may be transmitted to the touch electrode layer 21 through the above capacitance.

An adhesive layer 24 may be positioned below the display panel 251.

A magnetic shielding layer (e.g., a ferrite sheet, etc.) 25 may be attached under the display panel 251 through an adhesive layer 24.

The magnetic field shielding layer 25 may overlap with the adhesive layer 24 on the XY plane.

The adhesive 24 may be located over the entire area of the display panel 251, and the magnetic field shielding layer 25 may be located on the area where the adhesive 24 is located.

The magnetic field shielding layer 25 may block the magnetic field generated by the touch electrode of the touch electrode layer 21.

That is, the magnetic field shielding layer 25 may block a magnetic field that may affect other electronic components of the foldable electronic device 2 in FIG. 3.

As illustrated in FIG. 9, in the folded state, the folding area FA may be formed as a curved surface having at least a predetermined curvature.

The magnetic field shielding layer 25 that blocks the magnetic field is thick, is prone to deformation when the foldable electronic device 2 is folded, and may be damaged by repeated folding.

Stress is applied to the magnetic shielding layer 25 by repetition of the folding and unfolding states, which may ultimately result in damage to the magnetic shielding layer 25.

In addition, since the elongation and/or recovery rate of the magnetic shielding layer 25 and the adhesive layer 24 are different, peeling of the magnetic shielding layer 25 may occur due to repetition of the folding and unfolding states.

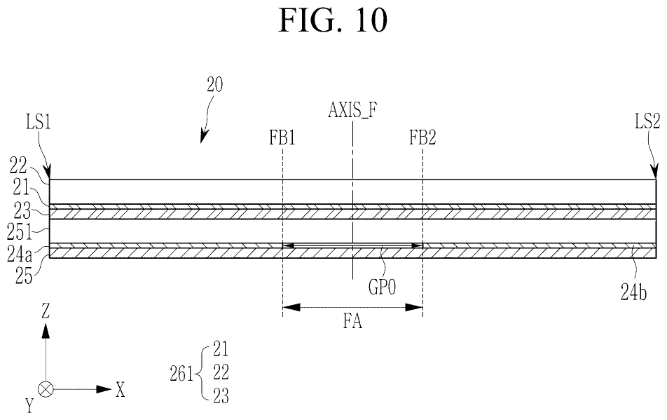

FIGS. 10 to 47 are drawings showing foldable electronic devices according to embodiments.

Referring to FIGS. 10 to 47, the touch screen 20 of the foldable electronic device includes a display panel 251 and a touch sensor 261 on the display panel 251.

The touch sensor 261 may include a substrate 23, a touch electrode layer 21 on the substrate, and a window 22 on the touch electrode layer 21.

The substrate 23 may be a sealing substrate of the display panel 251 or a color filter substrate of the display panel 251, and it is preferable that it be implemented with a transparent material.

The touch electrode layer 21 may include a plurality of first touch electrodes for detecting touch coordinates in a first direction and a plurality of second touch electrodes for detecting touch coordinates in a second direction intersecting the first direction.

In FIG. 10, the touch electrode layer 21 is illustrated as a single layer, but the first touch electrode and the second touch electrode may be positioned in different layers, may be positioned overlapping each other, may not be positioned overlapping each other, and a separate layer may be interposed between the first touch electrode and the second touch electrode, but is not limited thereto.

A window 22 may be positioned on the touch electrode layer 21.

The touch electrode layer 21, the conductive tip 11, and the window 22 may form capacitance.

Accordingly, a signal (resonance signal or active touch signal) generated from the stylus pen 10 may be transmitted to the touch electrode layer 21 through the capacitance.

An adhesive layer 24 may be positioned below the display panel 251.

The magnetic shielding layer 25 may be attached under the display panel 251 through the adhesive layer 24.

The thickness of the magnetic shielding layer 25 may be greater than the thickness of the adhesive layer 24.

The magnetic field shielding layer 25 may block the magnetic field generated by the touch electrode of the touch electrode layer 21.

That is, the magnetic field shielding layer 25 may block a magnetic field that may affect other electronic components of the foldable electronic device 2 in FIG. 3.

Referring to FIGS. 10 to 13, the magnetic shielding layer 25 may be attached to the display panel 251 through adhesive layers 24a, 24b.

The magnetic field shielding layer 25 may overlap with the adhesive layers 24a, 24b on the XY plane.

Referring to FIG. 10, the adhesive layers 24a, 24b may be positioned in an area excluding the folding area FA on the XY plane.

The adhesive 24a and the adhesive 24b may be spaced apart by a distance GPO substantially equal to the width of the folding area FA in the first direction.

That is, the separation distance GPO may be substantially equal to the shortest distance between the first direction boundaries FB1, FB2 of the folding region FA.

Here, the area excluding the folding area FA means an area where the force acting on the adhesive layers 24a, 24b when the foldable electronic device 2 is in a folded state does not damage the folding area FA, and does not mean that the adhesive layers 24a, 24b are not completely located in the folding area FA.

For example, even if the adhesive layers 24a, 24b are located in a part of the folding area FA, if the adhesive layers 24a, 24b are not damaged when the foldable electronic device 2 is repeatedly deformed between the folded state and the unfolded state, this also corresponds to an area excluding the folding area FA.

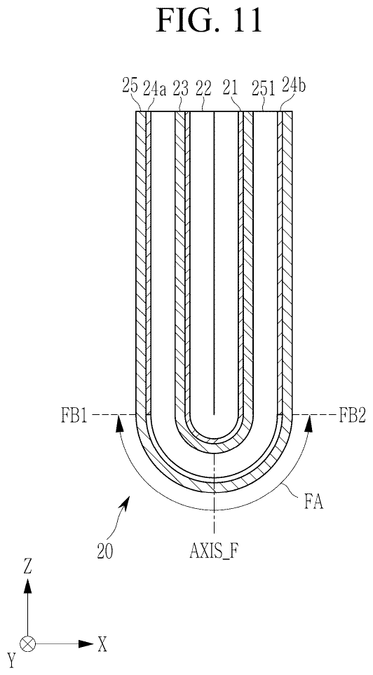

As a result, as illustrated in FIG. 11, even if the folding area FA is bent with respect to the folding axis AXIS_F, the risk of damage to the adhesive layers 24a, 24b and the magnetic field shielding layer 25 is reduced.

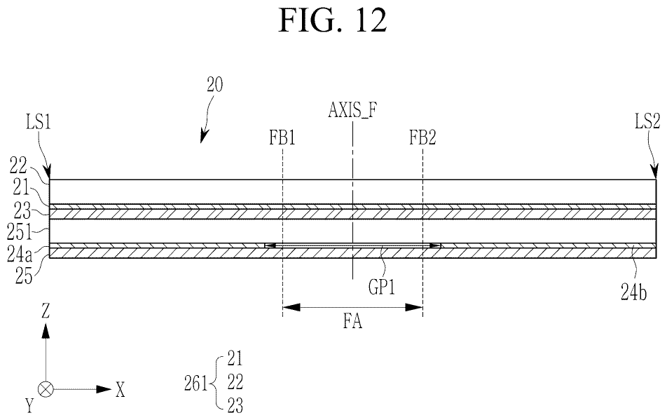

Referring to FIG. 12, the adhesive layers 24a, 24b may be positioned in an area excluding the folding area FA on the XY plane.

The adhesive 24a and the adhesive 24b may be spaced apart by a distance GPO longer than the first direction length of the folding area FA.

That is, the separation distance GPO may be longer than the shortest distance between the first direction boundaries FB1, FB2 of the folding region FA.

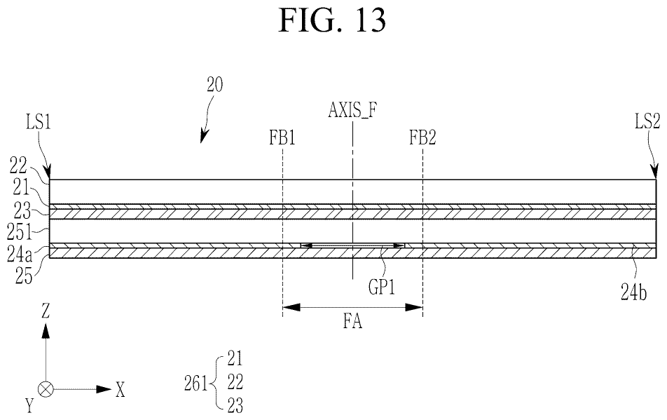

Referring to FIG. 13, the adhesive layers 24a, 24b may be positioned in an area excluding some areas within the folding area FA on the XY plane.

The adhesive 24a and the adhesive 24b may be spaced apart by a distance GPO shorter than the first direction length of the folding area FA.

That is, the separation distance GPO may be shorter than the shortest distance between the first direction boundaries FB1, FB2 of the folding region FA.

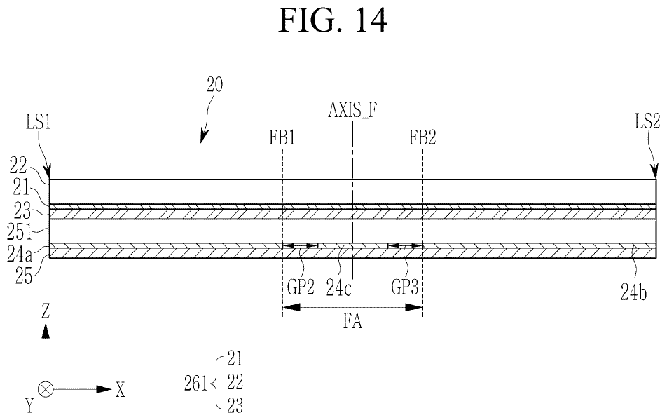

Referring to FIGS. 14 to 17, the magnetic shielding layer 25 may be attached to the display panel 251 through adhesive layers 24a, 24b, 24c.

The magnetic field shielding layer 25 may overlap with the adhesive layers 24a, 24b, 24c on the XY plane.

Referring to FIG. 14, the adhesive layers 24a, 24b may be positioned in an area excluding the folding area FA on the XY plane.

The adhesive 24c may be located within the folding area FA on the XY plane.

The adhesive 24a and the adhesive 24b may be spaced apart by a distance substantially equal to the width of the folding area FA in the first direction.

That is, the separation distance between the adhesive 24a and the adhesive 24b may be substantially equal to the shortest distance between the first direction boundaries FB1, FB2 of the folding area FA.

The separation distance GP2 between the adhesive 24a and the adhesive 24c may be substantially equal to the separation distance GP3 between the adhesive 24b and the adhesive 24c.

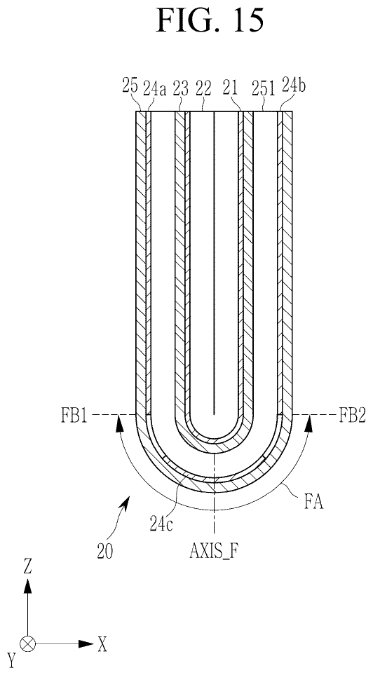

As a result, as illustrated in FIG. 15, even if the folding area FA is bent with respect to the folding axis AXIS_F, the risk of damage to the adhesive layers 24a, 24b, 24c and the magnetic field shielding layer 25 is reduced.

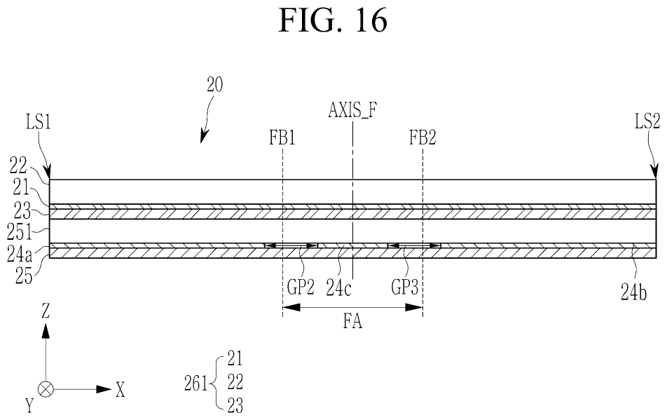

Referring to FIG. 16, the adhesive layers 24a, 24b may be positioned in an area excluding the folding area FA on the XY plane.

The adhesive 24c may be located within the folding area FA on the XY plane.

The adhesive 24a and the adhesive 24b may be spaced apart by a distance longer than the first direction length of the folding area FA.

That is, the separation distance between the adhesive 24a and the adhesive 24b may be longer than the shortest distance between the first direction boundaries FB1, FB2 of the folding area FA.

The separation distance GP2 between the adhesive 24a and the adhesive 24c may be substantially equal to the separation distance GP3 between the adhesive 24b and the adhesive 24c.

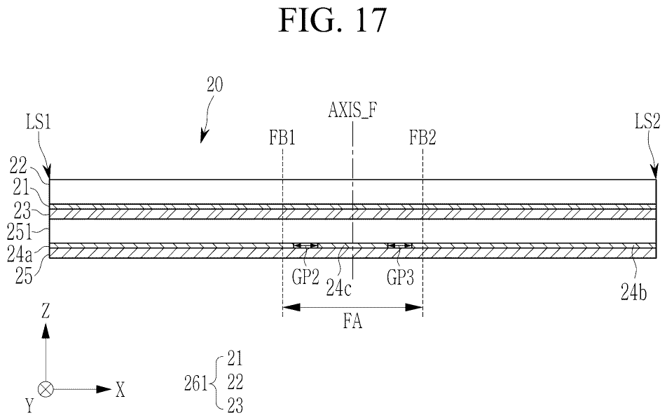

Referring to FIG. 17, the adhesive layers 24a, 24b may be positioned in an area excluding some areas within the folding area FA on the XY plane.

The adhesive 24c may be located within the folding area FA on the XY plane.

The adhesive 24a and the adhesive 24b may be spaced apart by a distance shorter than the first direction length of the folding area FA.

That is, the separation distance between the adhesive 24a and the adhesive 24b may be shorter than the shortest distance between the first direction boundaries FB1, FB2 of the folding area FA.

The separation distance GP2 between the adhesive 24a and the adhesive 24c may be substantially equal to the separation distance GP3 between the adhesive 24b and the adhesive 24c.

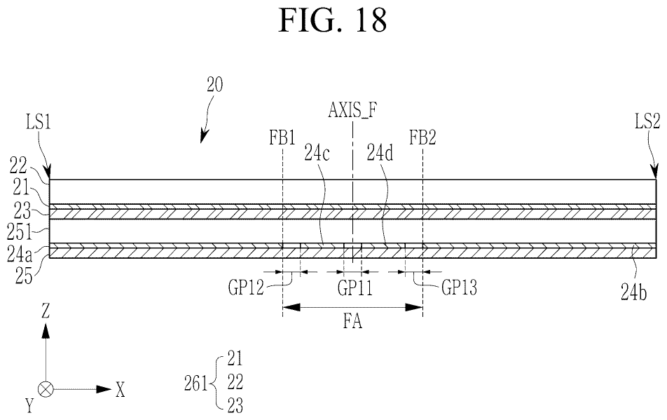

Referring to FIGS. 18 to 23, the magnetic field shielding layer 25 may be attached to the display panel 251 through adhesive layers (24a, 24b, 24c, 24d).

The magnetic field shielding layer 25 may overlap with the adhesive layers (24a, 24b, 24c, 24d) on the XY plane.

Referring to FIG. 18, the adhesive layers 24a, 24b may be positioned in an area excluding the folding area FA on the XY plane.

The adhesives 24c, 24d may be located within the folding area FA on the XY plane.

The adhesive 24a and the adhesive 24b may be spaced apart by a distance substantially equal to the width of the folding area FA in the first direction.

That is, the separation distance between the adhesive 24a and the adhesive 24b may be substantially equal to the shortest distance between the first direction boundaries FB1, FB2 of the folding area FA.

The separation distance GP11 between the adhesive 24c and the adhesive 24d, the separation distance GP12 between the adhesive 24a and the adhesive 24c, and the separation distance GP13 between the adhesive 24b and the adhesive 24c may be substantially the same.

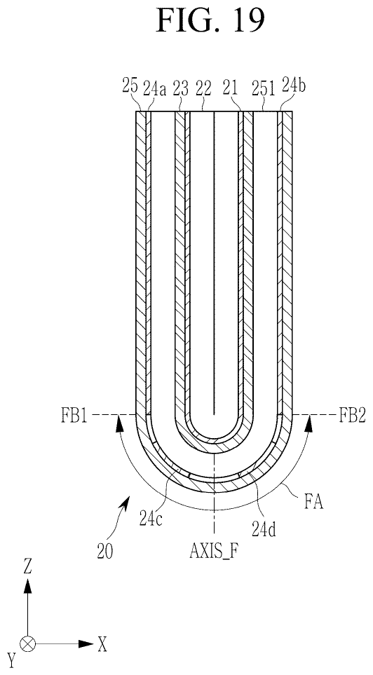

As a result, as illustrated in FIG. 19, even if the folding area FA is bent with respect to the folding axis AXIS_F, the risk of damage to the adhesive layers (24a, 24b, 24c, 24d) and the magnetic field shielding layer 25 is reduced.

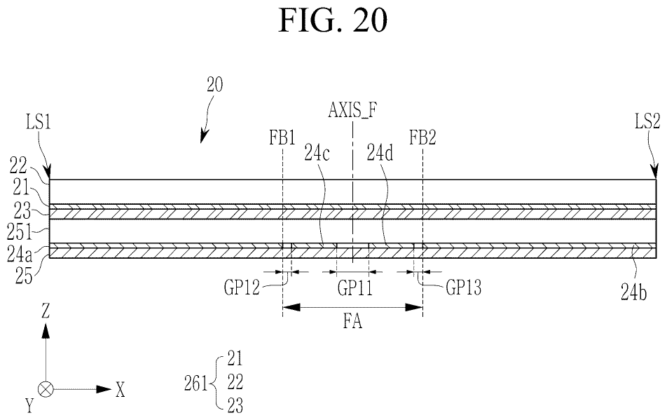

Referring to FIG. 20, the adhesive layers 24a, 24b may be positioned in an area excluding the folding area FA on the XY plane.

The adhesives 24c, 24d may be located within the folding area FA on the XY plane.

The adhesive 24a and the adhesive 24b may be spaced apart by a distance substantially equal to the width of the folding area FA in the first direction.

That is, the separation distance between the adhesive 24a and the adhesive 24b may be substantially equal to the shortest distance between the first direction boundaries FB1, FB2 of the folding area FA.

The separation distance GP11 between the adhesive 24c and the adhesive 24d may be longer than the separation distance GP12 between the adhesive 24a and the adhesive 24c and the separation distance GP13 between the adhesive 24b and the adhesive 24c.

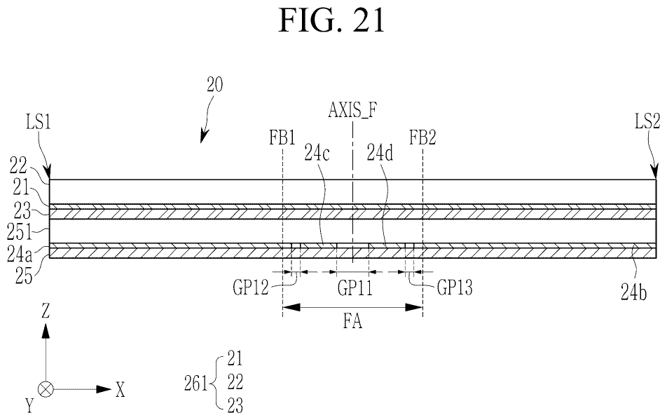

Referring to FIG. 21, the adhesive layers 24a, 24b may be positioned in an area excluding some areas within the folding area FA on the XY plane.

The adhesives 24c, 24d may be located within the folding area FA on the XY plane.

The adhesive 24a and the adhesive 24b may be spaced apart by a distance shorter than the first direction length of the folding area FA.

That is, the separation distance between the adhesive 24a and the adhesive 24b may be shorter than the shortest distance between the first direction boundaries FB1, FB2 of the folding area FA.

The separation distance GP11 between the adhesive 24c and the adhesive 24d may be longer than the separation distance GP12 between the adhesive 24a and the adhesive 24c and the separation distance GP13 between the adhesive 24b and the adhesive 24c.

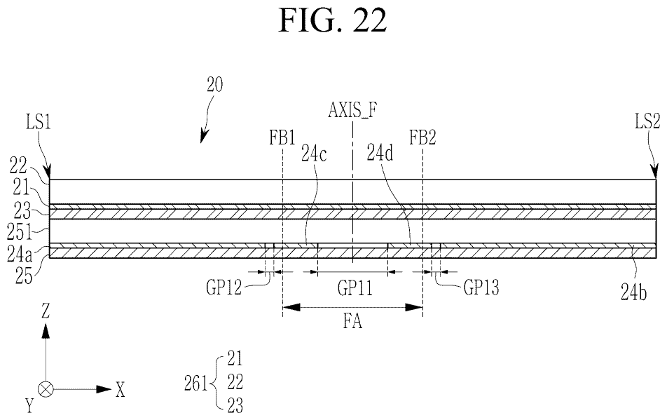

Referring to FIG. 22, the adhesive layers 24a, 24b may be positioned in an area excluding some areas within the folding area FA on the XY plane.

Each of the adhesives 24c, 24d may be positioned across each of the boundaries FB1, FB2 of the folding region FA on the XY plane.

The adhesive 24a and the adhesive 24b may be spaced apart by a distance longer than the first direction length of the folding area FA.

That is, the separation distance between the adhesive 24a and the adhesive 24b may be longer than the shortest distance between the first direction boundaries FB1, FB2 of the folding area FA.

The separation distance GP11 between the adhesive 24c and the adhesive 24d may be longer than the separation distance GP12 between the adhesive 24a and the adhesive 24c and the separation distance GP13 between the adhesive 24b and the adhesive 24c.

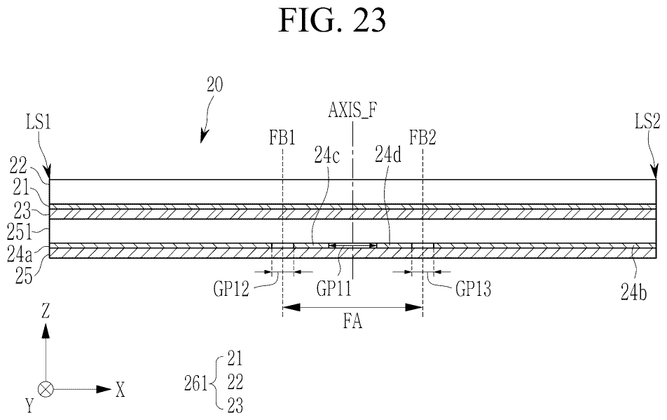

Referring to FIG. 23, the adhesive layers 24a, 24b may be positioned in an area excluding some areas within the folding area FA on the XY plane.

The adhesives 24c, 24d may be located within the folding area FA on the XY plane.

The adhesive 24a and the adhesive 24b may be spaced apart by a distance longer than the first direction length of the folding area FA.

That is, the separation distance between the adhesive 24a and the adhesive 24b may be longer than the shortest distance between the first direction boundaries FB1, FB2 of the folding area FA.

The separation distance GP11 between the adhesive 24c and the adhesive 24d may be longer than the separation distance GP12 between the adhesive 24a and the adhesive 24c and the separation distance GP13 between the adhesive 24b and the adhesive 24c.

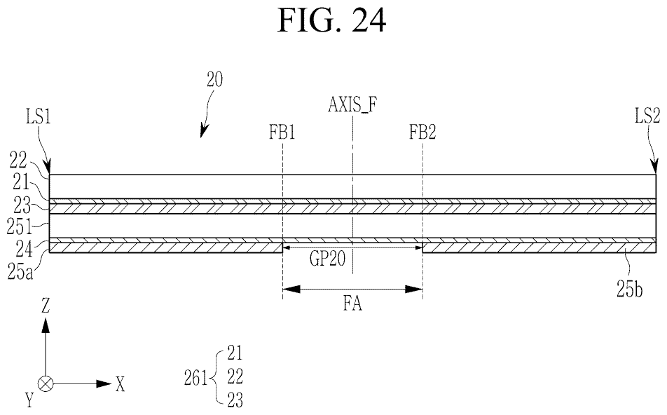

Referring to FIGS. 24 to 27, the magnetic field shielding layers 25a, 25b may be attached to the display panel 251 through the adhesive layer 24.

The magnetic shielding layers 25a, 25b may overlap with the adhesive layer 24 in the XY plane.

Referring to FIG. 24, the magnetic field shielding layers 25a, 25b may be positioned in an area excluding the folding area FA on the XY plane.

The magnetic field shielding layer 25a and the magnetic field shielding layer 25b may be spaced apart by a distance GP20 substantially equal to the width of the folding area FA in the first direction.

That is, the separation distance GP20 may be substantially equal to the shortest distance between the first direction boundaries FB1, FB2 of the folding area FA.

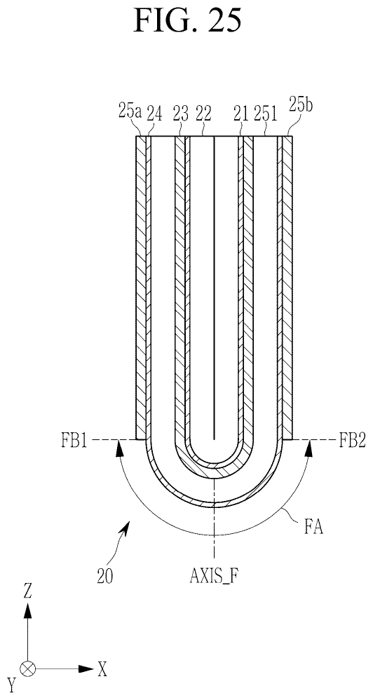

As a result, as illustrated in FIG. 25, even if the folding area FA is bent with respect to the folding axis AXIS_F, the risk of damage to the adhesive layer 24 and the magnetic field shielding layers 25a, 25b is reduced.

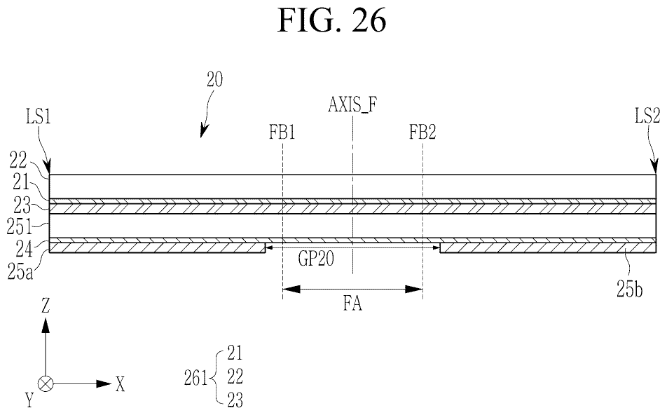

Referring to FIG. 26, the magnetic field shielding layers 25a, 25b may be positioned in an area excluding the folding area FA on the XY plane.

The magnetic field shielding layer 25a and the magnetic field shielding layer 25b may be spaced apart by a distance GP20 longer than the first direction length of the folding area FA.

That is, the separation distance GP20 may be longer than the shortest distance between the first direction boundaries FB1, FB2 of the folding area FA.

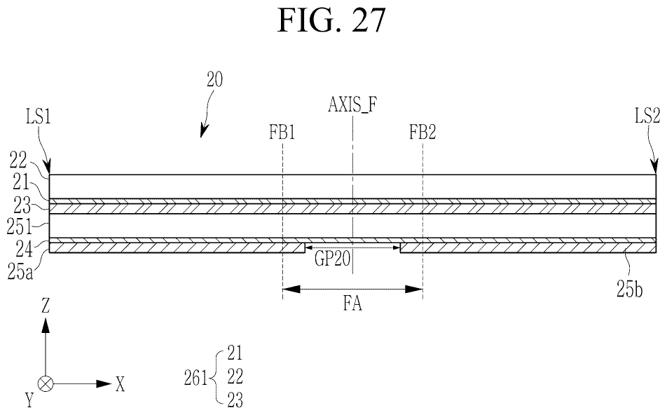

Referring to FIG. 27, the magnetic field shielding layers 25a, 25b may be positioned in an area excluding some areas within the folding area FA on the XY plane.

The magnetic field shielding layer 25a and the magnetic field shielding layer 25b may be spaced apart by a distance GP20 shorter than the first direction length of the folding area FA.

That is, the separation distance GP20 may be shorter than the shortest distance between the first direction boundaries FB1, FB2 of the folding area FA.

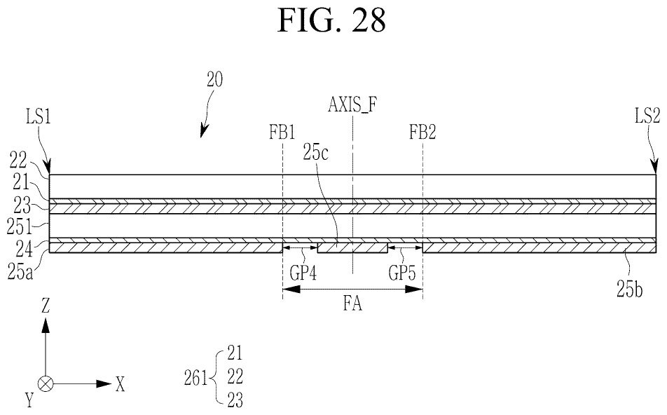

Referring to FIGS. 28 to 31, the magnetic field shielding layers 25a, 25b, 25c may be attached to the display panel 251 through the adhesive layer 24.

The magnetic shielding layers 25a, 25b, 25c may overlap with the adhesive layer 24 in the XY plane.

Referring to FIG. 28, the magnetic field shielding layers 25a, 25b may be positioned in an area excluding the folding area FA on the XY plane.

The magnetic field shielding layer 25c may be located within the folding area FA on the XY plane.

The magnetic field shielding layer 25a and the magnetic field shielding layer 25b may be spaced apart by a distance substantially equal to the width of the folding area FA in the first direction.

That is, the separation distance between the magnetic field shielding layer 25a and the magnetic field shielding layer 25b may be substantially equal to the shortest distance between the first direction boundaries FB1, FB2 of the folding area FA.

The separation distance GP4 between the magnetic field shielding layer 25a and the magnetic field shielding layer 25c may be substantially equal to the separation distance GP5 between the magnetic field shielding layer 25b and the magnetic field shielding layer 25c.

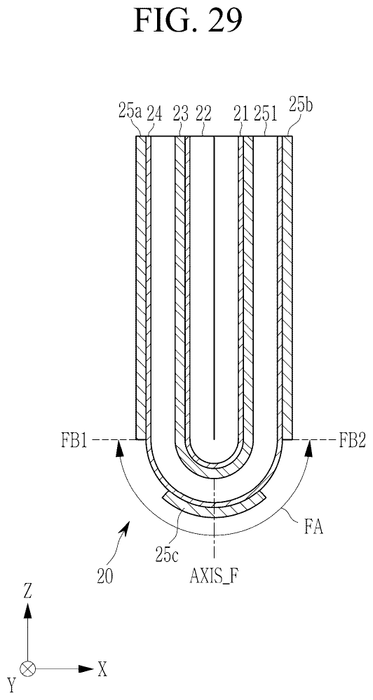

As a result, as illustrated in FIG. 29, even if the folding area FA is bent with respect to the folding axis AXIS_F, the risk of damage to the adhesive layer 24 and the magnetic field shielding layers 25a, 25b, 25c is reduced.

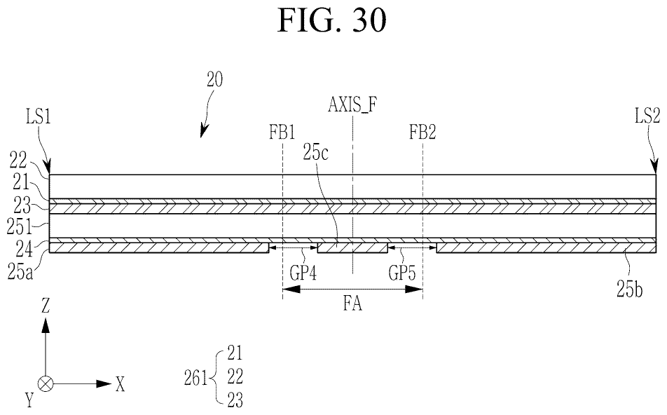

Referring to FIG. 30, the magnetic field shielding layers 25a, 25b may be positioned in an area excluding the folding area FA on the XY plane.

The magnetic field shielding layer 25c may be located within the folding area FA on the XY plane.

The magnetic field shielding layer 25a and the magnetic field shielding layer 25b may be spaced apart by a distance longer than the first direction length of the folding area FA.

That is, the separation distance between the magnetic field shielding layer 25a and the magnetic field shielding layer 25b may be longer than the shortest distance between the first direction boundaries FB1, FB2 of the folding area FA.

The separation distance GP4 between the magnetic field shielding layer 25a and the magnetic field shielding layer 25c may be substantially equal to the separation distance GP5 between the magnetic field shielding layer 25b and the magnetic field shielding layer 25c.

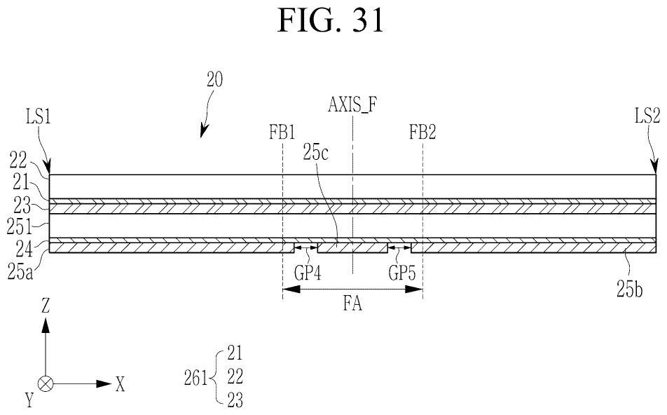

Referring to FIG. 31, the magnetic field shielding layers 25a, 25b may be positioned in an area excluding some areas within the folding area FA on the XY plane.

The magnetic field shielding layer 25c may be located within the folding area FA on the XY plane.

The magnetic field shielding layer 25a and the magnetic field shielding layer 25b may be spaced apart by a distance shorter than the first direction length of the folding area FA.

That is, the separation distance between the magnetic field shielding layer 25a and the magnetic field shielding layer 25b may be shorter than the shortest distance between the first direction boundaries FB1, FB2 of the folding area FA.

The separation distance GP4 between the magnetic field shielding layer 25a and the magnetic field shielding layer 25c may be substantially equal to the separation distance GP5 between the adhesive 24b and the adhesive 24c.

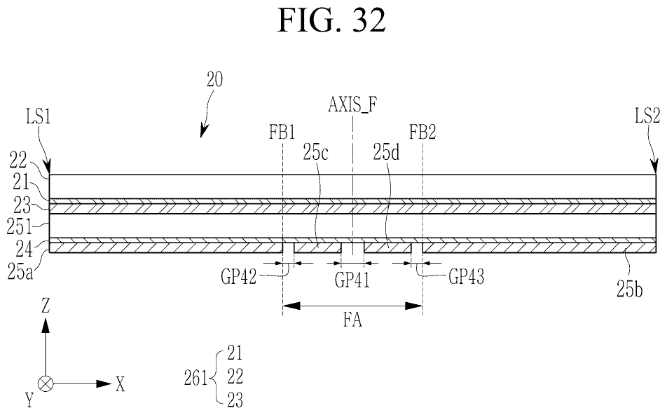

Referring to FIGS. 32 to 37, magnetic field shielding layers (25a, 25b, 25c, 25d) may be attached to the display panel 251 via the adhesive layer 24.

The magnetic shielding layers (25a, 25b, 25c, 25d) may overlap with the adhesive layer 24 in the XY plane.

Referring to FIG. 32, the magnetic field shielding layers 25a, 25b may be positioned in an area excluding some areas within the folding area FA on the XY plane.

The magnetic field shielding layers 25c, 25d may be positioned within the folding area FA on the XY plane.

The magnetic field shielding layer 25a and the magnetic field shielding layer 25b may be spaced apart by a distance substantially equal to the width of the folding area FA in the first direction.

That is, the separation distance between the magnetic field shielding layer 25a and the magnetic field shielding layer 25b may be substantially equal to the shortest distance between the first direction boundaries FB1, FB2 of the folding area FA.

The separation distance GP42 between the magnetic field shielding layer 25a and the magnetic field shielding layer 25c may be substantially equal to the separation distance GP43 between the magnetic field shielding layer 25b and the magnetic field shielding layer 25c.

The separation distance GP41 between the magnetic field shielding layer 25c and the magnetic field shielding layer 25d, the separation distance GP42 between the magnetic field shielding layer 25a and the magnetic field shielding layer 25c, and the separation distance GP43 between the magnetic field shielding layer 25b and the magnetic field shielding layer 25c may be substantially the same.

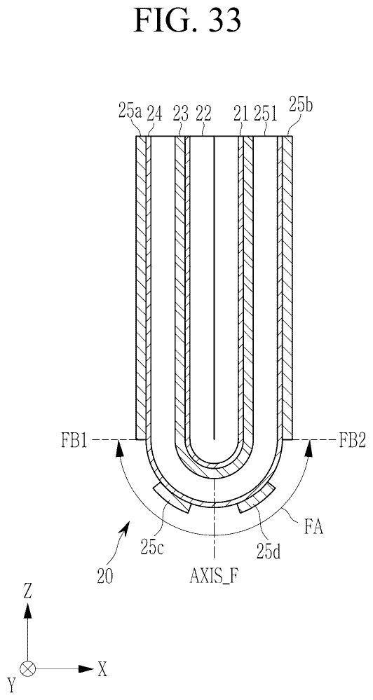

As a result, as illustrated in FIG. 33, even if the folding area FA is bent with respect to the folding axis AXIS_F, the risk of damage to the adhesive layer 24 and the magnetic field shielding layers (25a, 25b, 25c, 25d) is reduced.

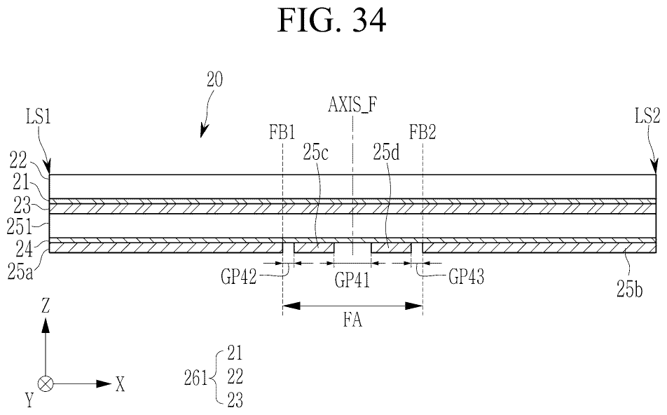

Referring to FIG. 34, the magnetic field shielding layers 25a, 25b may be positioned in an area excluding the folding area FA on the XY plane.

The magnetic field shielding layers 25c, 25d may be positioned within the folding area FA on the XY plane.

The magnetic field shielding layer 25a and the magnetic field shielding layer 25b may be spaced apart by a distance substantially equal to the width of the folding area FA in the first direction.

That is, the separation distance between the magnetic field shielding layer 25a and the magnetic field shielding layer 25b may be substantially equal to the shortest distance between the first direction boundaries FB1, FB2 of the folding area FA.

The separation distance GP21 between the magnetic field shielding layer 25c and the magnetic field shielding layer 25d may be longer than the separation distance GP22 between the magnetic field shielding layer 25a and the magnetic field shielding layer 25c and the separation distance GP23 between the magnetic field shielding layer 25b and the magnetic field shielding layer 25c.

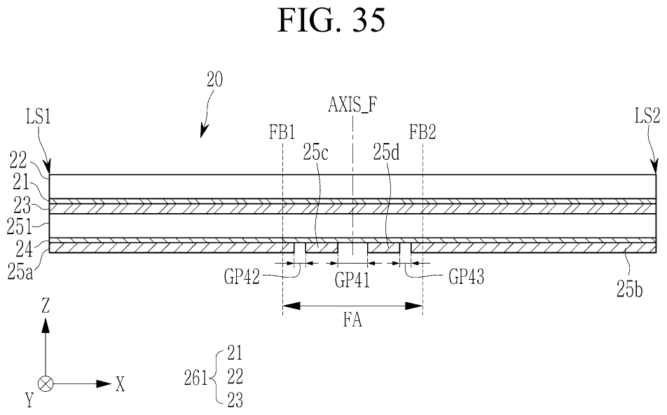

Referring to FIG. 35, the magnetic field shielding layers 25a, 25b may be positioned in an area excluding some areas within the folding area FA on the XY plane.

The magnetic field shielding layers 25c, 25d may be positioned within the folding area FA on the XY plane.

The magnetic field shielding layer 25a and the magnetic field shielding layer 25b may be spaced apart by a distance shorter than the first direction length of the folding area FA.

That is, the separation distance between the magnetic field shielding layer 25a and the magnetic field shielding layer 25b may be shorter than the shortest distance between the first direction boundaries FB1, FB2 of the folding area FA.

The separation distance GP21 between the magnetic field shielding layer 25c and the magnetic field shielding layer 25d may be longer than the separation distance GP22 between the magnetic field shielding layer 25a and the magnetic field shielding layer 25c and the separation distance GP23 between the magnetic field shielding layer 25b and the magnetic field shielding layer 25c.

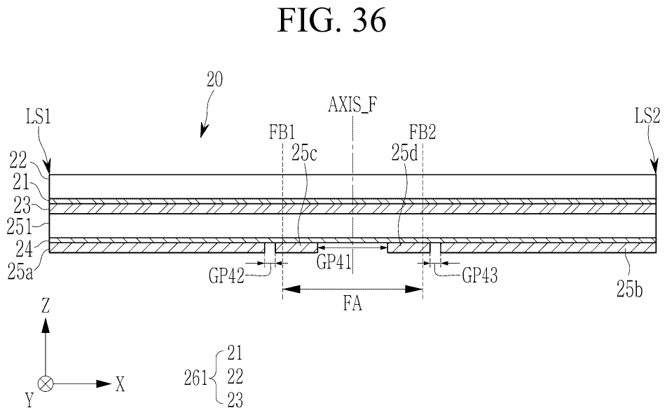

Referring to FIG. 36, the magnetic field shielding layers 25a, 25b may be positioned in an area excluding some areas within the folding area FA on the XY plane.

Each of the magnetic shielding layers 25c, 25d may be positioned across each of the boundaries FB1, FB2 of the folding region FA in the XY plane.

The magnetic field shielding layer 25a and the magnetic field shielding layer 25b may be spaced apart by a distance longer than the first direction length of the folding area FA.

That is, the separation distance between the magnetic field shielding layer 25a and the magnetic field shielding layer 25b may be longer than the shortest distance between the first direction boundaries FB1, FB2 of the folding area FA.

The separation distance GP21 between the magnetic field shielding layer 25c and the magnetic field shielding layer 25d may be longer than the separation distance GP22 between the magnetic field shielding layer 25a and the magnetic field shielding layer 25c and the separation distance GP23 between the magnetic field shielding layer 25b and the magnetic field shielding layer 25c.

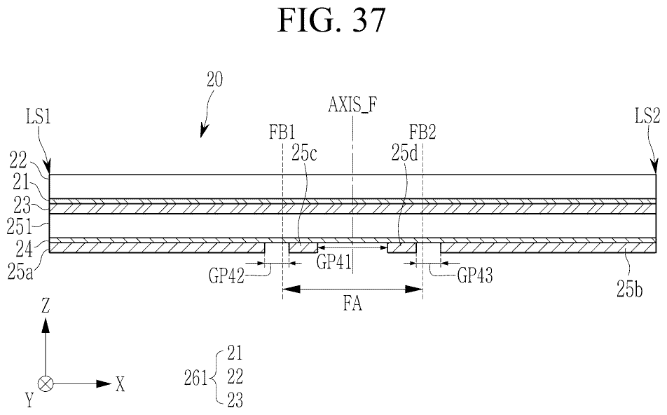

Referring to FIG. 37, the magnetic field shielding layers 25a, 25b may be positioned in an area excluding some areas within the folding area FA on the XY plane.

The magnetic field shielding layers 25c, 25d may be positioned within the folding area FA on the XY plane.

The magnetic field shielding layer 25a and the magnetic field shielding layer 25b may be spaced apart by a distance longer than the first direction length of the folding area FA.

That is, the separation distance between the magnetic field shielding layer 25a and the magnetic field shielding layer 25b may be longer than the shortest distance between the first direction boundaries FB1, FB2 of the folding area FA.

The separation distance GP21 between the magnetic field shielding layer 25c and the magnetic field shielding layer 25d may be longer than the separation distance GP22 between the magnetic field shielding layer 25a and the magnetic field shielding layer 25c and the separation distance GP23 between the magnetic field shielding layer 25b and the magnetic field shielding layer 25c.

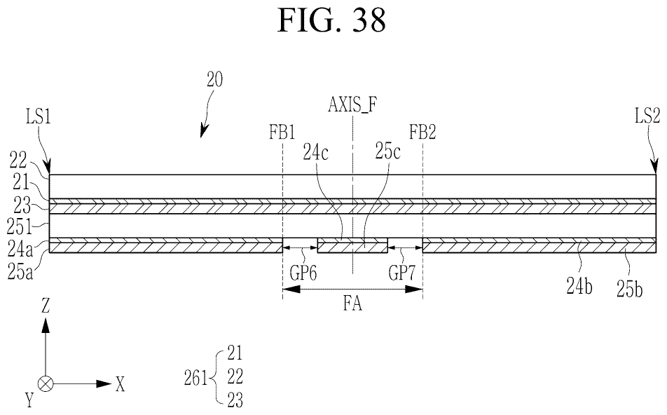

Referring to FIGS. 38 to 41, the sub-magnetic field shielding layers 25a, 25b, 25c may be attached to the display panel 251 via adhesive layers 24a, 24b, 24c.

Each of the sub-magnetic shielding layers 25a, 25b, 25c may overlap each of the adhesive layers 24a, 24b, 24c in the XY plane.

In some embodiments, the length (e.g., width) of the first direction of the overlapping magnetic shielding layer (e.g., 25c) and the adhesive layer (e.g., 24c) may be substantially equal to each other.

In some embodiments, the length (e.g., width) of the first direction of the overlapping magnetic shielding layer (e.g., 25c) and the adhesive layer (e.g., 24c) may be different from each other.

For example, the first direction boundary of the magnetic field shielding layer 25c may be located beyond the first direction boundaries of the adhesive layer 24c.

In some embodiments, the XY plane widths of the overlapping magnetic field shielding layer 25c and the adhesive layer 24c may be different from each other.

Referring to FIG. 38, the adhesive layers 24a, 24b and the sub-magnetic field shielding layers 25a, 25b may be positioned in an area excluding the folding area FA on the XY plane.

The adhesive 24c and the magnetic field shielding layer 25c may be positioned within the folding area FA on the XY plane.

The adhesive 24a and the adhesive 24b may be spaced apart by a distance substantially equal to the width of the folding area FA in the first direction.

That is, the separation distance between the adhesive 24a and the adhesive 24b may be substantially equal to the shortest distance between the first direction boundaries FB1, FB2 of the folding area FA.

The magnetic field shielding layer 25a and the magnetic field shielding layer 25b may be spaced apart by a distance substantially equal to the width of the folding area FA in the first direction.

That is, the separation distance between the magnetic field shielding layer 25a and the magnetic field shielding layer 25b may be substantially equal to the shortest distance between the first direction boundaries FB1, FB2 of the folding area FA.

The separation distance GP6 between the adhesive 24a and the adhesive 24c may be substantially equal to the separation distance GP7 between the adhesive 24b and the adhesive 24c.

The separation distance GP6 between the magnetic field shielding layer 25a and the magnetic field shielding layer 25c may be substantially equal to the separation distance GP7 between the magnetic field shielding layer 25b and the magnetic field shielding layer 25c.

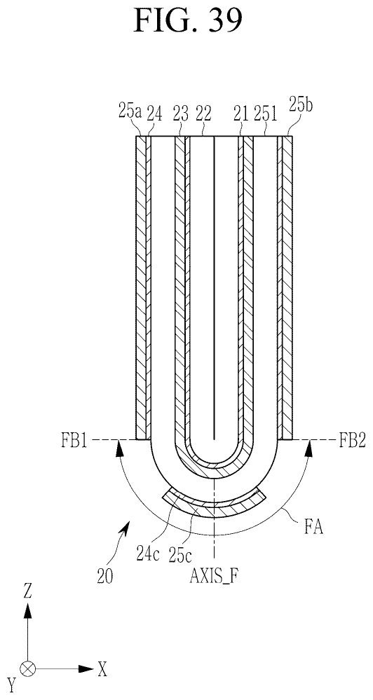

As a result, even if the folding area FA is bent with respect to the folding axis AXIS_F as illustrated in FIG. 39, the risk of damage to the adhesive layers 24a, 24b, 24c and the sub-magnetic field shielding layers 25a, 25b, 25c is reduced.

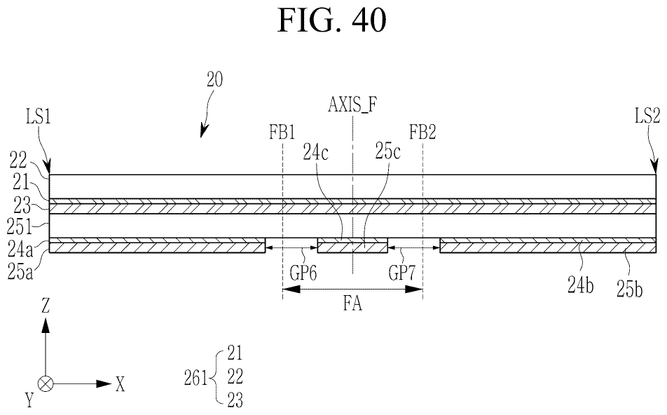

Referring to FIG. 40, the adhesive layers 24a, 24b and the sub-magnetic field shielding layers 25a, 25b may be positioned in an area excluding the folding area FA on the XY plane.

The adhesive 24c and the magnetic field shielding layer 25c may be positioned within the folding area FA on the XY plane.

The adhesive 24a and the adhesive 24b may be spaced apart by a distance longer than the first direction length of the folding area FA.

That is, the separation distance between the adhesive 24a and the adhesive 24b may be longer than the shortest distance between the first direction boundaries FB1, FB2 of the folding area FA.

The magnetic field shielding layer 25a and the magnetic field shielding layer 25b may be spaced apart by a distance longer than the first direction length of the folding area FA.

That is, the separation distance between the magnetic field shielding layer 25a and the magnetic field shielding layer 25b may be longer than the shortest distance between the first direction boundaries FB1, FB2 of the folding area FA.

The separation distance GP6 between the adhesive 24a and the adhesive 24c may be substantially equal to the separation distance GP7 between the adhesive 24b and the adhesive 24c.

The separation distance GP6 between the magnetic field shielding layer 25a and the magnetic field shielding layer 25c may be substantially equal to the separation distance GP7 between the magnetic field shielding layer 25b and the magnetic field shielding layer 25c.

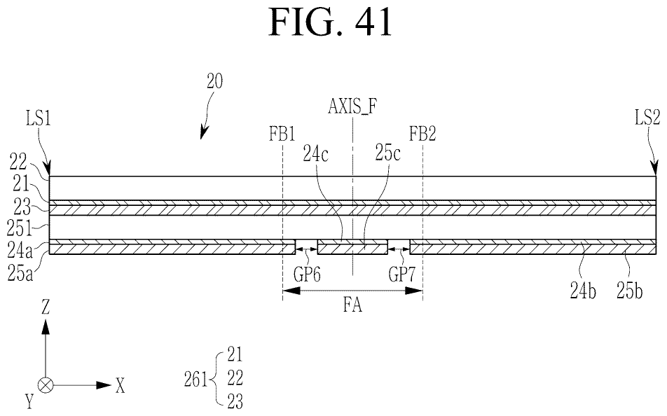

Referring to FIG. 41, the adhesive layers 24a, 24b and the sub-magnetic field shielding layers 25a, 25b may be positioned in an area excluding some areas within the folding area FA on the XY plane.

The adhesive 24c and the magnetic field shielding layer 25c may be positioned within the folding area FA on the XY plane.

The adhesive 24a and the adhesive 24b may be spaced apart by a distance shorter than the first direction length of the folding area FA.

That is, the separation distance between the adhesive 24a and the adhesive 24b may be shorter than the shortest distance between the first direction boundaries FB1, FB2 of the folding area FA.

The magnetic field shielding layer 25a and the magnetic field shielding layer 25b may be spaced apart by a distance shorter than the first direction length of the folding area FA.

That is, the separation distance between the magnetic field shielding layer 25a and the magnetic field shielding layer 25b may be shorter than the shortest distance between the first direction boundaries FB1, FB2 of the folding area FA.

The separation distance GP6 between the adhesive 24a and the adhesive 24c may be substantially equal to the separation distance GP7 between the adhesive 24b and the adhesive 24c.

The separation distance GP6 between the magnetic field shielding layer 25a and the magnetic field shielding layer 25c may be substantially equal to the separation distance GP7 between the magnetic field shielding layer 25 and the magnetic field shielding layer 25c.

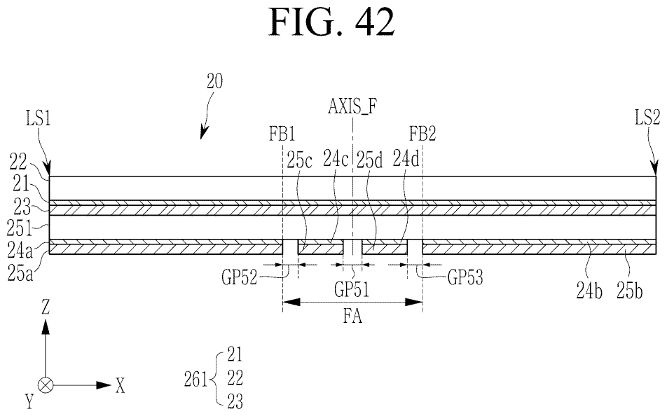

Referring to FIGS. 42 to 47, sub-magnetic field shielding layers (25a, 25b, 25c, 25d) may be attached to the display panel 251 via adhesive layers (24a, 24b, 24c, 24d).

Each of the sub-magnetic field shielding layers (25a, 25b, 25c, 25d) may overlap each of the adhesive layers (24a, 24b, 24c, 24d) in the XY plane.

In some embodiments, the lengths of the first direction of the overlapping magnetic shielding layer (e.g., 25c) and the adhesive layer (e.g., 24c) may be different from each other.

For example, the first direction boundary of the magnetic field shielding layer 25c may be located beyond the first direction boundaries of the adhesive layer 24c.

In some embodiments, the XY plane widths of the overlapping magnetic field shielding layer 25c and the adhesive layer 24c may be different from each other.

Referring to FIG. 42, the adhesive layers 24a, 24b and the sub-magnetic field shielding layers 25a, 25b may be positioned in an area excluding the folding area FA on the XY plane.

The adhesives 24c, 24d and the sub-magnetic shielding layers 25c, 25d may be positioned within the folding area FA on the XY plane.

The adhesive 24a and the adhesive 24b may be spaced apart by a distance substantially equal to the width of the folding area FA in the first direction.

That is, the separation distance between the adhesive 24a and the adhesive 24b may be substantially equal to the shortest distance between the first direction boundaries FB1, FB2 of the folding area FA.

The magnetic field shielding layer 25a and the magnetic field shielding layer 25b may be spaced apart by a distance substantially equal to the width of the folding area FA in the first direction.

That is, the separation distance between the magnetic field shielding layer 25a and the magnetic field shielding layer 25b may be substantially equal to the shortest distance between the first direction boundaries FB1, FB2 of the folding area FA.

The separation distance GP51 between the adhesive 24c and the adhesive 24d, the separation distance GP52 between the adhesive 24a and the adhesive 24c, and the separation distance GP53 between the adhesive 24b and the adhesive 24c may be substantially the same.

The separation distance GP4 between the magnetic field shielding layer 25a and the magnetic field shielding layer 25c may be substantially equal to the separation distance GP5 between the magnetic field shielding layer 25b and the magnetic field shielding layer 25c.

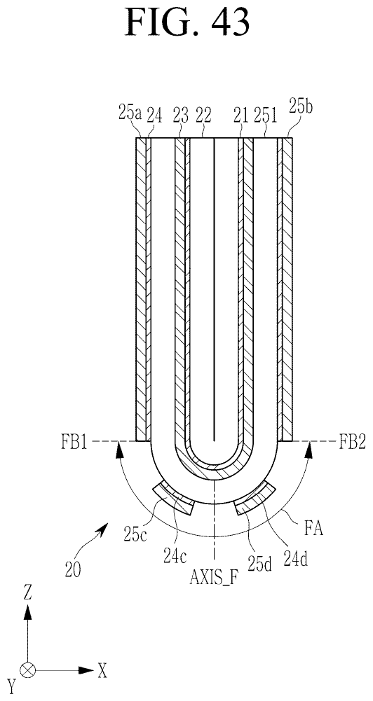

As a result, as illustrated in FIG. 43, even if the folding area FA is bent with respect to the folding axis AXIS_F, the risk of damage to the adhesive layers (24a, 24b, 24c, 24d) and the sub-magnetic field shielding layers (25a, 25b, 25c, 25d) is reduced.

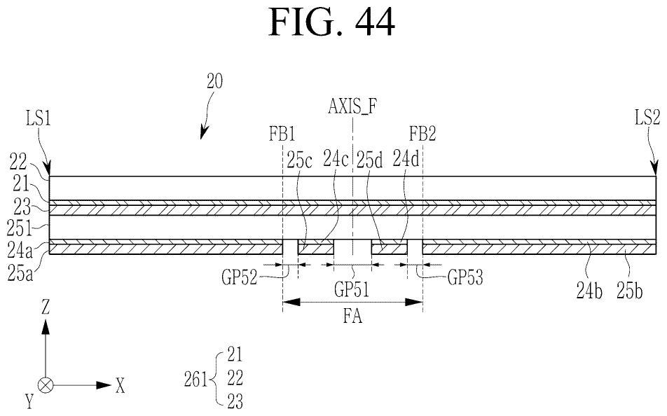

Referring to FIG. 44, the adhesive layers 24a, 24b and the sub-magnetic field shielding layers 25a, 25b may be positioned in an area excluding the folding area FA on the XY plane.

The adhesives 24c, 24d and the sub-magnetic shielding layers 25c, 25d may be positioned within the folding area FA on the XY plane.

The adhesive 24a and the adhesive 24b may be spaced apart by a distance substantially equal to the width of the folding area FA in the first direction.

That is, the separation distance between the adhesive 24a and the adhesive 24b may be substantially equal to the shortest distance between the first direction boundaries FB1, FB2 of the folding area FA.

The magnetic field shielding layer 25a and the magnetic field shielding layer 25b may be spaced apart by a distance substantially equal to the width of the folding area FA in the first direction.

That is, the separation distance between the magnetic field shielding layer 25a and the magnetic field shielding layer 25b may be substantially equal to the shortest distance between the first direction boundaries FB1, FB2 of the folding area FA.

The separation distance GP51 between the adhesive 24c and the adhesive 24d may be longer than the separation distance GP52 between the adhesive 24a and the adhesive 24c and the separation distance GP53 between the adhesive 24b and the adhesive 24c.

The separation distance GP51 between the magnetic field shielding layer 25c and the magnetic field shielding layer 25d may be longer than the separation distance GP52 between the magnetic field shielding layer 25a and the magnetic field shielding layer 25c and the separation distance GP53 between the magnetic field shielding layer 25b and the magnetic field shielding layer 25c.

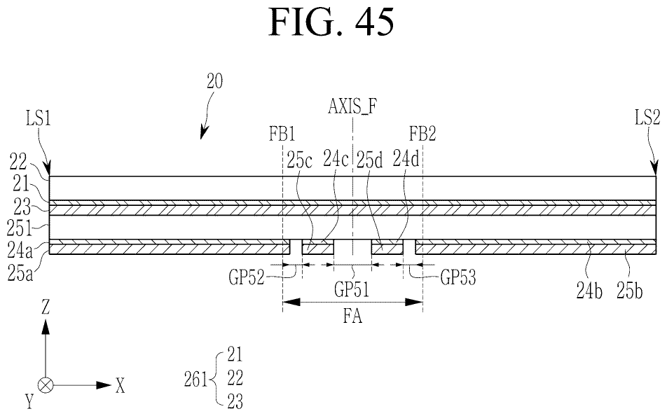

Referring to FIG. 45, the adhesive layers 24a, 24b and the sub-magnetic field shielding layers 25a, 25b may be positioned in an area excluding some areas within the folding area FA on the XY plane.

The adhesives 24c, 24d and the sub-magnetic shielding layers 25c, 25d may be positioned within the folding area FA on the XY plane.

The adhesive 24a and the adhesive 24b may be spaced apart by a distance shorter than the first direction length of the folding area FA.

That is, the separation distance between the adhesive 24a and the adhesive 24b may be shorter than the shortest distance between the first direction boundaries FB1, FB2 of the folding area FA.

The magnetic field shielding layer 25a and the magnetic field shielding layer 25b may be spaced apart by a distance shorter than the first direction length of the folding area FA.

That is, the separation distance between the magnetic field shielding layer 25a and the magnetic field shielding layer 25b may be shorter than the shortest distance between the first direction boundaries FB1, FB2 of the folding area FA.

The separation distance GP51 between the adhesive 24c and the adhesive 24d may be longer than the separation distance GP52 between the adhesive 24a and the adhesive 24c and the separation distance GP53 between the adhesive 24b and the adhesive 24c.

The separation distance GP51 between the magnetic field shielding layer 25c and the magnetic field shielding layer 25d may be longer than the separation distance GP52 between the magnetic field shielding layer 25a and the magnetic field shielding layer 25c and the separation distance GP53 between the magnetic field shielding layer 25b and the magnetic field shielding layer 25c.

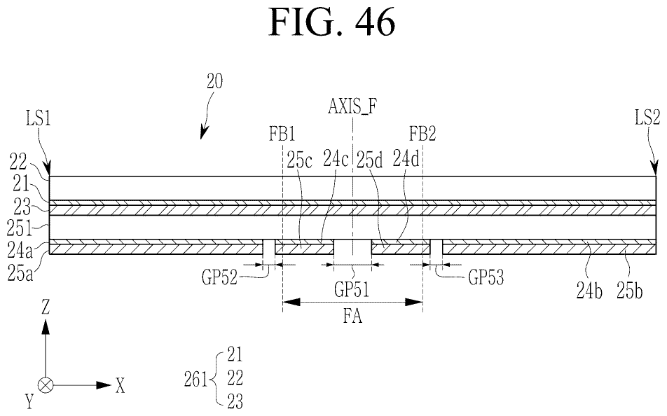

Referring to FIG. 46, the adhesive layers 24a, 24b and the sub-magnetic field shielding layers 25a, 25b may be positioned in an area excluding some areas within the folding area FA on the XY plane.

Each of the adhesives 24c, 24d and the sub-magnetic shielding layers 25c, 25d may be positioned across each of the boundaries FB1, FB2 of the folding region FA in the XY plane.

The adhesive 24a and the adhesive 24b may be spaced apart by a distance longer than the first direction length of the folding area FA.

That is, the separation distance between the adhesive 24a and the adhesive 24b may be longer than the shortest distance between the first direction boundaries FB1, FB2 of the folding area FA.

The magnetic field shielding layer 25a and the magnetic field shielding layer 25b may be spaced apart by a distance longer than the first direction length of the folding area FA.

That is, the separation distance between the magnetic field shielding layer 25a and the magnetic field shielding layer 25b may be longer than the shortest distance between the first direction boundaries FB1, FB2 of the folding area FA.

The separation distance GP51 between the adhesive 24c and the adhesive 24d may be longer than the separation distance GP52 between the adhesive 24a and the adhesive 24c and the separation distance GP53 between the adhesive 24b and the adhesive 24c.

The separation distance GP51 between the magnetic field shielding layer 25c and the magnetic field shielding layer 25d may be longer than the separation distance GP52 between the magnetic field shielding layer 25a and the magnetic field shielding layer 25c and the separation distance GP53 between the magnetic field shielding layer 25b and the magnetic field shielding layer 25c.

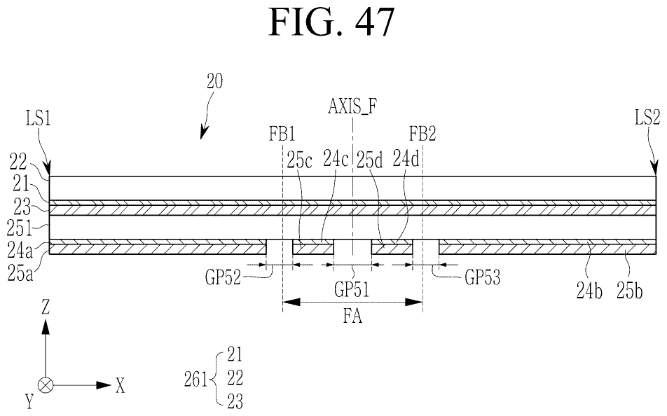

Referring to FIG. 47, the adhesive layers 24a, 24b and the sub-magnetic field shielding layers 25a, 25b may be positioned in an area excluding some areas within the folding area FA on the XY plane.

The adhesives 24c, 24d and the sub-magnetic shielding layers 25c, 25d may be positioned within the folding area FA on the XY plane.

The adhesive 24a and the adhesive 24b may be spaced apart by a distance longer than the first direction length of the folding area FA.

That is, the separation distance between the adhesive 24a and the adhesive 24b may be longer than the shortest distance between the first direction boundaries FB1, FB2 of the folding area FA.

The magnetic field shielding layer 25a and the magnetic field shielding layer 25b may be spaced apart by a distance longer than the first direction length of the folding area FA.

That is, the separation distance between the magnetic field shielding layer 25a and the magnetic field shielding layer 25b may be longer than the shortest distance between the first direction boundaries FB1, FB2 of the folding area FA.

The separation distance GP51 between the adhesive 24c and the adhesive 24d may be longer than the separation distance GP52 between the adhesive 24a and the adhesive 24c and the separation distance GP53 between the adhesive 24b and the adhesive 24c.

The separation distance GP51 between the magnetic field shielding layer 25c and the magnetic field shielding layer 25d may be longer than the separation distance GP52 between the magnetic field shielding layer 25a and the magnetic field shielding layer 25c and the separation distance GP53 between the magnetic field shielding layer 25b and the magnetic field shielding layer 25c.

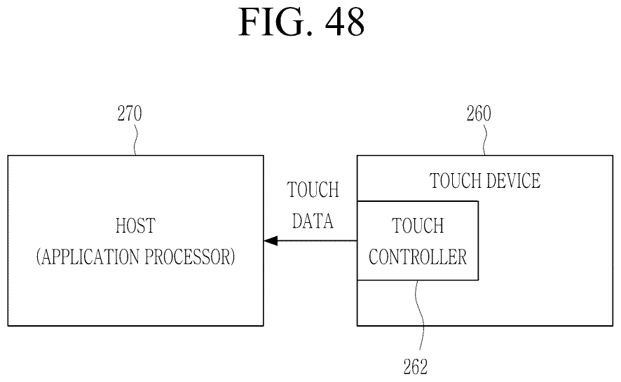

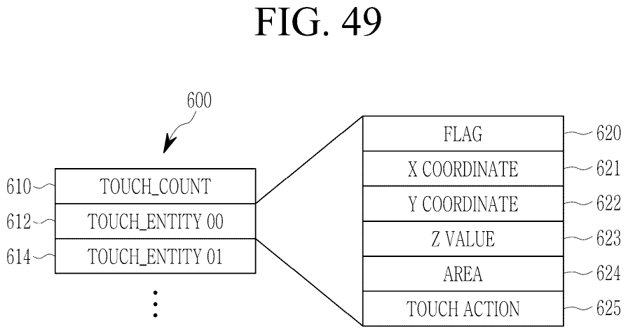

FIG. 48 is a block diagram showing a touch module and a host according to embodiments, and FIG. 49 is a drawing showing an example of touch data provided to a host from a touch module according to embodiments.

Referring to FIG. 48, the host 270 may receive touch data from the touch controller 262 included in the touch module 260.

For example, the host 270 may be a mobile System-on-Chip SoC, an Application Processor AP, a Media Processor, a microprocessor, a Central Processing Unit CPU, or a similar device.

After one frame ends, the touch module 260 may generate information about touch input during one frame as touch data and transmit it to the host 270.

Referring to FIGS. 48 and 49, touch data 600 may be transmitted from a touch module 260 to a host 270 and may include a touch count field 610 and at least one touch entity field 612, 614.

A value indicating the number of touches input during one frame period may be entered in the touch count field 610.

The touch entity fields 612, 614 include fields representing information about each touch input.

For example, the touch entity field 612, 614 includes a flag field 620, an X-axis coordinate field 621, a Y-axis coordinate field 622, a Z value field 623, an area field 624, and a touch action field 625.

The number of touch entity fields 612, 614 may be equal to the value entered in the touch count field 61.

A value representing a touch object may be entered in the flag field 620.

For example, a finger, a palm, and a stylus pen may be entered into the flag field 620 with different values.

The X-axis coordinate field 621 and the Y-axis coordinate field 622 may be filled with values representing calculated touch coordinates.

A value corresponding to the signal strength of the detection signal may be entered in the Z value field 623.

A value corresponding to the area of the touched area may be entered in the area field 624.

According to embodiments, the host device 270 that receives touch data 600 uses the value of the area field 624 to determine that the touch object is a finger if the touch area is greater than a threshold, and determines that the touch object is a stylus pen 10 if the touch area is less than the threshold.

According to embodiments, the host device 270 that receives touch data 600 may use the value of the flag field 620 to identify whether the touch object is a finger or a stylus pen 10.

Electronic devices according to various embodiments disclosed in this disclosure may be devices of various forms.

The electronic device may include, for example, a portable communication device (e.g., a smartphone), a computer device, a portable multimedia device, a portable medical device, a camera, a wearable device, or a consumer electronics device.

Electronic devices according to embodiments of this disclosure are not limited to the above-described devices.

It should be understood that the various embodiments and terms used in this disclosure are not intended to limit the technical features described in this disclosure to specific embodiments, but rather to encompass various modifications, equivalents, or alternatives of the embodiments.

In connection with the description of the drawings, similar reference numerals may be used for similar or related components.

The singular form of a noun corresponding to an item may include one or more of said items, unless the context clearly indicates otherwise.

In this disclosure, each of the phrases “A or B,” “at least one of A and B,” “at least one of A or B,” “A, B, or C,” “at least one of A, B, and C,” and “at least one of A, B, or C” may include all possible combinations of the items listed in that phrase.

Terms such as “first”, “second”, or “first” or “second” may be used merely to distinguish one component from another, and do not limit the components in any other respect (e.g., importance or order).

When a component (e.g., a first component) is referred to as being “coupled” or “connected” to another component (e.g., a second component), with or without the terms “functionally” or “communicatively,” it means that the component may be connected to the other component directly (e.g., wired), wirelessly, or through a third component.

The term “module” as used in this disclosure may include units implemented in hardware, software or firmware, and may be used interchangeably with terms such as logic, logic block, component, or circuit.

A module may be a component that is configured integrally or a minimum unit of said component that performs one or more functions or a part thereof.

For example, according to an embodiment, the module may be implemented in the form of an application-specific integrated circuit ASIC.

Various embodiments of this disclosure may be implemented as software (e.g., a program) including one or more instructions stored in a storage medium (e.g., built-in memory or external memory) readable by a machine (e.g., an electronic device).

For example, a processor (e.g., a processor) of a device (e.g., an electronic device) may recall at least one command from among one or more instructions stored from a storage medium and execute it.

This enables the device to be operated to perform at least one function in response to at least one command invoked above.

The one or more of the instructions may include code generated by a compiler or code executable by an interpreter.

The device-readable storage medium may be provided in the form of a non-transitory storage medium.

Here, ‘non-transitory’ simply means that the storage medium is a tangible device and does not contain signals (e.g. electromagnetic waves), and the term does not distinguish between cases where data is stored semi-permanently or temporarily on the storage medium.

According to an embodiment, the methods according to various embodiments disclosed in the present disclosure may be provided as included in a computer program product.

Computer program products may be traded between sellers and buyers as commodities.

The computer program product may be distributed in the form of a machine-readable storage medium (e.g., a compact disc read only memory (CD-ROM)), or may be distributed online (e.g., by download or upload) via an application store (e.g., Play Store™) or directly between two user devices (e.g., smartphones).

In the case of online distribution, at least a portion of the computer program product may be temporarily stored or temporarily created in a machine-readable storage medium, such as the memory of a manufacturer's server, an application store's server, or an intermediary server.

According to various embodiments, each component (e.g., a module or a program) of the components described above may include one or more entities.

According to various embodiments, one or more of the aforementioned components or operations may be omitted, or one or more other components or operations may be added.

Alternatively or additionally, the plurality of components (e.g., modules or programs) may be integrated into a single component.

In such a case, the integrated component may perform one or more functions of each of the plurality of components identically or similarly to those performed by the corresponding component among the plurality of components prior to the integration.

According to various embodiments, the operations performed by a module, program or other component may be performed sequentially, in parallel, iteratively, or heuristically, or one or more of the operations may be performed in a different order, omitted, or one or more other operations may be added.

What is claimed is:

1. A foldable electronic device comprising:
a display panel configured to be folded along a folding axis parallel to a first direction;
a plurality of adhesive layers below the display panel, and positioned in an area excluding at least a portion of the folding area that forms a curved surface in a folded state of the display panel; and
a magnetic shielding layer attached under the display panel through the plurality of adhesive layers.

2. The foldable electronic device as claimed in claim 1, wherein
the plurality of adhesive layers include a first adhesive layer and a second adhesive layer spaced apart in a second direction intersecting the first direction.

3. The foldable electronic device as claimed in claim 2, wherein
a distance between the first adhesive layer and the second adhesive layer in the second direction is substantially the same as the width of the folding area in the second direction.

4. The foldable electronic device as claimed in claim 2, wherein
a distance between the first adhesive layer and the second adhesive layer in the second direction is longer than the width of the folding area in the second direction.

5. The foldable electronic device as claimed in claim 2, wherein
a distance between the first adhesive layer and the second adhesive layer in the second direction is shorter than the width of the folding area in the second direction.

6. The foldable electronic device as claimed in claim 1, wherein
the plurality of adhesive layers include a first adhesive layer and a second adhesive layer spaced apart in a second direction intersecting the first direction, and
the foldable electronic device further includes a third adhesive layer positioned between the first adhesive layer and the second adhesive layer along the second direction.

7. The foldable electronic device as claimed in claim 6, wherein
a distance between the first adhesive layer and the second adhesive layer in the second direction is substantially equal to the width of the folding area in the second direction, and
a distance in the second direction between the first adhesive layer and the third adhesive layer is substantially the same as a distance in the second direction between the second adhesive layer and the third adhesive layer.

8. The foldable electronic device as claimed in claim 6, wherein
a distance between the first adhesive layer and the second adhesive layer in the second direction is longer than the width of the folding area in the second direction, and
a distance in the second direction between the first adhesive layer and the third adhesive layer is substantially the same as a distance in the second direction between the second adhesive layer and the third adhesive layer.

9. The foldable electronic device as claimed in claim 6, wherein
a distance between the first adhesive layer and the second adhesive layer in the second direction is shorter than the width of the folding area in the second direction, and
a distance in the second direction between the first adhesive layer and the third adhesive layer is substantially the same as a distance in the second direction between the second adhesive layer and the third adhesive layer.

10. The foldable electronic device as claimed in claim 1, wherein
the plurality of adhesive layers include a first adhesive layer and a second adhesive layer spaced apart in a second direction intersecting the first direction, and
the foldable electronic device further includes a third adhesive layer and a fourth adhesive layer positioned between the first adhesive layer and the second adhesive layer along the second direction.

11. The foldable electronic device as claimed in claim 10, wherein
a distance between the first adhesive layer and the second adhesive layer in the second direction is substantially equal to the width of the folding area in the second direction, and
a distance in the second direction between the third adhesive layer and the fourth adhesive layer, a distance in the second direction between the first adhesive layer and the third adhesive layer, and a distance in the second direction between the second adhesive layer and the third adhesive layer are substantially the same as each other.

12. The foldable electronic device as claimed in claim 10, wherein
a distance between the first adhesive layer and the second adhesive layer in the second direction is substantially equal to the width of the folding area in the second direction, and
a distance in the second direction between the third adhesive layer and the fourth adhesive layer is longer than each of a distance in the second direction between the first adhesive layer and the third adhesive layer and a distance in the second direction between the second adhesive layer and the third adhesive layer.

13. The foldable electronic device as claimed in claim 10, wherein
a distance between the first adhesive layer and the second adhesive layer in the second direction is shorter than the width of the folding area in the second direction, and
a distance in the second direction between the third adhesive layer and the fourth adhesive layer is longer than each of a distance in the second direction between the first adhesive layer and the third adhesive layer and a distance in the second direction between the second adhesive layer and the third adhesive layer.

14. The foldable electronic device as claimed in claim 10, wherein
a distance between the first adhesive layer and the second adhesive layer in the second direction is longer than the width of the folding area in the second direction, and
a distance in the second direction between the third adhesive layer and the fourth adhesive layer is longer than each of a distance in the second direction between the first adhesive layer and the third adhesive layer and a distance in the second direction between the second adhesive layer and the third adhesive layer.

15. The foldable electronic device as claimed in claim 14, wherein
the third adhesive layer and the fourth adhesive layer are respectively positioned across the boundaries of the second direction of the folding area.

16. The foldable electronic device as claimed in claim 1, wherein
the magnetic field shielding layer includes a plurality of sub-magnetic field shielding layers spaced apart from each other corresponding to the plurality of adhesive layers.

17. The foldable electronic device as claimed in claim 16, wherein
the width of the second direction intersecting the first direction of a first sub-magnetic field shielding layer corresponding to one of the plurality of adhesive layers is different from the width of the second direction of the one adhesive layer.

18. The foldable electronic device as claimed in claim 16, wherein
the width of the second direction intersecting the first direction of a first sub-magnetic field shielding layer corresponding to one of the plurality of adhesive layers is substantially the same as the width of the second direction of the one adhesive layer.

19. A foldable electronic device comprising:
a display panel configured to be folded along a folding axis parallel to a first direction;
an adhesive layer positioned below the display panel; and
a plurality of magnetic field shielding layers attached under the display panel through the adhesive layer and positioned in an area excluding at least a portion of the folding area that forms a curved surface in a folded state of the display panel.

20. A foldable electronic device comprising:
a display panel configured to be folded along a folding axis parallel to a first direction;
a plurality of adhesive layers below the display panel, and positioned in an area excluding at least a portion of the folding area that forms a curved surface in a folded state of the display panel, and
a plurality of magnetic field shielding layers attached under the display panel through the plurality of adhesive layers, thicker than the thickness of the plurality of adhesive layers, and positioned in an area excluding at least a portion of the folding area that forms a curved surface in a folded state of the display panel.
